(19) United States
(12) Patent Application Publication
(10) Pub. No.: US 2026/0195815 A1
(43) Pub. Date: Jul. 9, 2026

(54) DETERMINATION OF UNCLAIMED ASSETS USING MACHINE LEARNING MODELS

(71) Applicant: International Business Machines Corporation, Armonk, NY (US)

(72) Inventors: Deepashree Gandhi, Bengaluru (IN); Shyamala Gowri, Bangalore (IN); Mrudula Madiraju, Bengaluru (IN); Rakhi S. Arora, Bengaluru (IN)

(21) Appl. No.: 19/009,395

(22) Filed: Jan. 3, 2025

(51) Int. Cl. G06Q 40/06; G06Q 40/02

(52) U.S. Cl. CPC G06Q 40/06; G06Q 40/02

(57) ABSTRACT

Determination of unclaimed assets using machine learning (ML) models is provided and includes receiving transaction data that includes a set of transactions associated with a first bank account of a specific user. A first ML model of a set of ML models is applied to the transaction data and each transaction of the set of transactions is classified into at least one category of a set of categories based on the application of the first ML model to the transaction data. Further, a second ML model of the set of ML models is applied to the classified set of transactions, and one or more financial holdings associated with the specific user are determined based on the application of the second ML model to the classified set of transactions. Based on the determined one or more financial holdings a wealth portfolio catalog is generated and outputted.

### BACKGROUND

The disclosure relates to determination of unclaimed assets and more particularly, to determination of unclaimed assets using machine learning (ML) models.

Unclaimed assets refer to financial holdings that remain dormant or unclaimed for a specified period. The unclaimed assets include bank deposits, dividends, unclaimed insurance payouts, and the like. When a financial account goes inactive due to the account holder's neglect or death, the funds are considered unclaimed. As per regulations, financial institutions must report these assets to the government, where these assets may be held until the rightful owner or their heirs come forward to claim them. The determination of unclaimed assets is vital for safeguarding the financial rights of individuals and ensuring that wealth is not lost indefinitely.

With growing financial literacy and awareness, individuals are increasingly recognizing the importance of tracking their assets. However, many unclaimed assets remain undiscovered, leading to a loss of potential wealth. Regulatory bodies and financial institutions play a crucial role in ensuring that users are informed about their rights and the processes necessary to claim these assets, ultimately enhancing financial inclusion and security. The applications of determining unclaimed assets are manifold. For individuals, this process serves to recover lost wealth, which can significantly improve their financial situation. Families can benefit from understanding their entitlements to deceased members' assets, facilitating smoother financial transitions during times of grief.

Moreover, governments can utilize the data collected from unclaimed assets to design better financial products and services, ensuring that they cater to the needs of their citizens more effectively. The reclaiming of these assets can enhance overall economic stability. Therefore, the benefit of identifying unclaimed assets extends beyond individuals and families to include societal benefits. Therefore, the determination of unclaimed assets is a significant area within financial management and consumer protection.

### SUMMARY

According to an embodiment of the disclosure, a computer-implemented method for the determination of unclaimed assets using machine learning (ML) models is described. The computer-implemented method includes receiving, by a computer, transaction data that includes a set of transactions associated with a first bank account of a specific user. The computer-implemented method further includes applying, by the computer, a first machine learning (ML) model of a set of ML models to the transaction data. The computer-implemented method further includes classifying, by the computer, each transaction of the set of transactions into at least one category of a set of categories based on the application of the first ML model to the transaction data. The computer-implemented method further includes applying, by the computer, a second ML model of the set of ML models to the classified set of transactions. The computer-implemented method further includes determining, by the computer, one or more financial holdings associated with the specific user based on the application of the second ML model to the classified set of transactions. The computer-implemented method further includes generating, by the computer, a wealth portfolio catalog associated with the specific user based on the determination of the one or more financial holdings. The computer-implemented method further includes outputting, by the computer, the generated wealth portfolio catalog.

According to one or more embodiments of the disclosure, a computer system for the determination of unclaimed assets using machine learning (ML) models is described. The computer system includes a processor set, one or more computer-readable storage media, and program instructions stored on the one or more computer-readable storage media. The program instructions are executable by the processor set and cause the processor set to receive transaction data that includes a set of transactions associated with a first bank account of a specific user. The program instructions further cause the processor set to apply a first machine learning (ML) model of a set of ML models to the transaction data. The program instructions further cause the processor set to classify each transaction of the set of transactions into at least one category of a set of categories based on the application of the first ML model to the transaction data. The program instructions further cause the processor set to apply a second ML model of the set of ML models to the classified set of transactions. The program instructions further cause the processor set to determine one or more financial holdings associated with the specific user based on the application of the second ML model to the classified set of transactions. The program instructions further cause the processor set to generate a wealth portfolio catalog associated with the specific user based on the determination of the one or more financial holdings. The program instructions further cause the processor set to output the generated wealth portfolio catalog.

According to one or more embodiments of the disclosure, a computer-program product for the determination of unclaimed assets using machine learning (ML) models is described. The computer program product includes one or more computer-readable storage media and program instructions stored in the one or more computer-readable storage media to perform operations that include receiving transaction data that includes a set of transactions associated with a first bank account of a specific user. The operations further include applying a first machine learning (ML) model of a set of ML models to the transaction data. The operations further include classifying each transaction of the set of transactions into at least one category of a set of categories based on the application of the first ML model to the transaction data. The operations further include applying a second ML model of the set of ML models to the classified set of transactions. The operations further include determining one or more financial holdings associated with the specific user based on the application of the second ML model to the classified set of transactions. The operations further include generating a wealth portfolio catalog associated with the specific user based on the determination of the one or more financial holdings. The operations further include outputting the generated wealth portfolio catalog.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for determination of unclaimed assets using machine learning (ML) models, in accordance with an embodiment of the disclosure;

FIG. 2 is a diagram that illustrates an environment for determination of unclaimed assets using machine learning (ML) models, in accordance with an embodiment of the disclosure;

FIG. 3 is a diagram that illustrates exemplary operations for determination of unclaimed assets using machine learning (ML) models, in accordance with an embodiment of the disclosure;

FIG. 4 is a diagram that illustrates exemplary operations for determination of a set of features for determination of unclaimed assets using machine learning (ML) models, in accordance with an embodiment of the disclosure;

FIG. 5 is a diagram that illustrates exemplary operations for training a machine learning (ML) model for determination of unclaimed assets, in accordance with an embodiment of the disclosure;

FIG. 6A is a diagram that illustrates an exemplary first user interface for determination of unclaimed assets using machine learning (ML) models, in accordance with an embodiment of the disclosure;

FIG. 6B is a diagram that illustrates an exemplary second user interface for determination of unclaimed assets using machine learning (ML) models, in accordance with an embodiment of the disclosure; and

FIG. 7 is a diagram that illustrates a flowchart of an exemplary method for determination of unclaimed assets using machine learning (ML) models, in accordance with an embodiment of the disclosure.

### DETAILED DESCRIPTION

Determination of unclaimed assets is a significant area within financial management and consumer protection. This field encompasses various financial instruments, including bank deposits, shares, mutual funds, and insurance policies. With growing financial literacy and awareness, individuals are increasingly recognizing the importance of tracking their assets. However, many unclaimed assets remain undiscovered, leading to a loss of potential wealth. Regulatory bodies and financial institutions play a crucial role in ensuring that users are informed about their rights and the processes necessary to claim these assets, enhancing financial inclusion and security.

Unclaimed assets refer to financial holdings that remain dormant or unclaimed for a specified period. The unclaimed assets include bank deposits, dividends, unclaimed insurance payouts, and the like. When a financial account goes inactive due to the account holder's neglect or death, the funds are considered unclaimed. As per regulations, financial institutions must report these assets to the government, where they may be held until the rightful owner or their heirs come forward to claim them. The determination of unclaimed assets is vital for safeguarding the financial rights of individuals and ensuring that wealth is not lost indefinitely.

The applications of determining unclaimed assets are manifold. For individuals, the determination of unclaimed assets serves as a means to recover lost wealth, which can significantly improve their financial situation. Families can benefit from understanding their entitlements to deceased members' assets, facilitating smoother financial transitions during times of grief. Moreover, organizations and financial institutions use the determination of unclaimed assets to enhance their outreach strategies, creating targeted programs aimed at recovering unclaimed assets.

Additionally, the determination of unclaimed assets can significantly benefit the economy of a country. When unclaimed assets are reclaimed, they contribute to increased liquidity within the financial system of the country. The determination of unclaimed assets allows funds to be reinvested into the economy, which stimulates growth and provides new opportunities for businesses and individuals. Such advantages of determination of unclaimed assets extend beyond individuals and families to include societal benefits. By promoting transparency in financial transactions and encouraging people to track their assets, financial institutions can foster trust among consumers. Furthermore, raising awareness about unclaimed assets can empower users, leading to informed financial decisions and increased participation in the financial ecosystem.

However, many challenges arise in the process of determination of unclaimed assets. One significant issue is the lack of awareness among individuals regarding their financial holdings. Many people are unaware of the existence of unclaimed accounts or assets held in their name or the family member's name. This ignorance can result in unclaimed funds accumulating over time. Additionally, the documentation required to claim these assets can be cumbersome, leading to frustration and discouragement among potential claimants. Therefore, a streamlined approach to documentation is required to mitigate this barrier.

Moreover, the process can become even more complex in the event of a sudden death. Families may struggle to locate vital documents or access accounts, particularly if the deceased did not maintain clear records of their financial dealings. Emotional distress can cloud judgment, making it challenging to navigate the necessary steps for asset recovery. In these situations, effective communication and education about asset recovery processes are vital. Financial institutions must offer resources to help families understand their rights and the steps needed to reclaim their loved ones' unclaimed assets.

Traditional methods of determination of unclaimed assets relied on tracking user investments, which can be time-consuming and inefficient. These methods were focused on online investments like shares and fixed deposits, leaving many assets unaccounted for. They also struggle to capture transactions made on different platforms, leading to incomplete information. This makes it hard for people to know about all the unclaimed assets they might have, preventing them from getting back what belongs to them.

Additionally, these traditional approaches fail to account for non-digital assets like real estate, jewelry, and other valuables that people usually keep private. These assets are frequently forgotten and not included in standard recovery processes. Families may find it difficult to locate wealth left behind by deceased members, which adds to their stress during a challenging time. This lack of tracking for physical assets not only affects individual families but also leads to significant amounts of wealth remaining unclaimed and unused. Therefore, there is a need for an improved approach to the determination of unclaimed assets to solve the problems.

The disclosed system aims to provide a proactive approach to the determination of unclaimed assets. The disclosed system does not require real-time tracking of user investments, which makes it efficient to use and solves the problems associated with the traditional methods The real-time tracking of user investments is a time-consuming and tedious task that requires high-end computing resources. The need for these high-end computational resources increases the overall cost of the determination of unclaimed assets. Therefore, the disclosed system provides a solution to determine unclaimed assets by analyzing historical transaction data and not real-time tracking of user investments which reduces the overall computer processing time of a computing system or computing resources for the determination of unclaimed assets. Hence, the disclosed system provides a time-effective method for the computing systems and the computing resources to determine unclaimed assets.

The disclosed system provides the solution for determination of unclaimed assets by analyzing the historical transaction data and does not rely on the real-time tracking of the user investments. Hence, the disclosed system determines the unclaimed assets in one go rather than relying on the real-time tracking of user investments which further eliminates the need for high-end computing resources for the determination of the unclaimed assets. The need for these high-end computational resources increases the overall cost of the determination of unclaimed assets. Therefore, the disclosed system reduces the overall cost of the process of determination of the unclaimed assets since it eliminates the need for high-end computing resources. Moreover, the disclosed system provides a way to track digital assets like shares and fixed deposits (FDs) as well as non-digital assets like real estate and jewelry which eliminates the limitations of the traditional methods. The disclosed system provides a single-point summary of the investor in the lifetime and later which makes the life of the nominee easier and hassle-free.

The disclosed system further performs the determination of the unclaimed assets based on a single data source which reduces the possibility of errors as compared to the traditional methods which relied on multiple data sources. Therefore, the disclosed system provides a reliable method for the determination of the unclaimed assets. The disclosed system further can be linked with one or more financial institutions to provide the determination of unclaimed assets as a value-added service to users. Furthermore, the disclosed system can be further used by governments to distribute funds which in turn will impact and improve the economy.

The disclosed system can be further used by individuals to track their assets and liabilities. The disclosed system can also be utilized to identify unclaimed assets in case of an unfortunate event. This feature can be invaluable for children or dependents, helping them navigate the complex process of asset recovery during a difficult time following the unfortunate event.

According to an embodiment of the disclosure, a computer-implemented method for the determination of unclaimed assets using machine learning (ML) models is described. The computer-implemented method includes receiving, by a computer, transaction data that includes a set of transactions associated with a first bank account of a specific user. The computer-implemented method further includes applying, by the computer, a first machine learning (ML) model of a set of ML models to the transaction data. The computer-implemented method further includes classifying, by the computer, each transaction of the set of transactions into at least one category of a set of categories based on the application of the first ML model to the transaction data. The computer-implemented method further includes applying, by the computer, a second ML model of the set of ML models to the classified set of transactions. The computer-implemented method further includes determining, by the computer, one or more financial holdings associated with the specific user based on the application of the second ML model to the classified set of transactions. The computer-implemented method further includes generating, by the computer, a wealth portfolio catalog associated with the specific user based on the determination of the one or more financial holdings. The computer-implemented method further includes outputting, by the computer, the generated wealth portfolio catalog.

In various embodiments of the disclosure, the set of categories includes a deposit category, a loan category, an investments category, a real estate category, a jewelry category, and a transfer category. The transfer category is associated with a transfer of funds from the first bank account of the specific user to a second bank account of the specific user.

In various embodiments of the disclosure, the computer-implemented method further includes obtaining, by the computer, a set of dictionaries associated with the determined one or more financial holdings. The computer-implemented method further includes applying, by the computer, the first ML model of the set of ML models to the set of dictionaries. The computer-implemented method further includes determining, by the computer, a set of features associated with each financial holding of the one or more financial holdings based on the application of the first ML model to the set of dictionaries. The computer-implemented method further includes generating, by the computer, the wealth portfolio catalog associated with the specific user based on the determination of the set of features.

In various embodiments of the disclosure, the set of features includes a first feature associated with a price value of each financial holding of the one or more financial holdings, a second feature associated with a maturity amount of each financial holding of the one or more financial holdings, and a third feature associated with a payment schedule of each financial holding of the one or more financial holdings.

In various embodiments of the disclosure, the computer-implemented method further includes extracting, by the computer, one or more key identifiers associated with each transaction of the set of transactions based on the transaction data. Each identifier of the one or more identifiers is associated with a corresponding transaction of the set of transactions. The computer-implemented method further includes applying, by the computer, the first ML model of the set of ML models to the one or more key identifiers. The computer-implemented method further includes classifying, by the computer, each transaction of the set of transactions into the at least one category of the set of categories based on the application of the first ML model to the one or more key identifiers.

In various embodiments of the disclosure, the one or more key identifiers include a monetary value associated with each transaction of the set of transactions, a transaction date associated with each transaction of the set of transactions, timestamp data associated with each transaction of the set of transactions, payee data associated with each transaction of the set of transactions, payer data associated with each transaction of the set of transactions, transaction remarks associated with each transaction of the set of transactions, and a transaction code associated with each transaction of the set of transactions.

In various embodiments of the disclosure, the computer-implemented method further includes applying, by the computer, one or more data processing techniques to the transaction data. The computer-implemented method further includes generating, by the computer, one or more tokens associated with the set of transactions based on the application of the one or more data processing techniques. Each token of the one or more tokens is associated with the corresponding transaction of the set of transactions. The computer-implemented method includes extracting, by the computer, the one or more key identifiers associated with each transaction of the set of transactions based on the generation of the one or more tokens.

In various embodiments of the disclosure, the computer-implemented method further includes identifying, by the computer, one or more recurring transactions from the set of transactions based on the transaction data. The disclosed computer-implemented method includes classifying, by the computer, each transaction of the set of transactions into the at least one category of the set of categories based on the identification of one or more recurring transactions.

In various embodiments of the disclosure, the computer-implemented method further includes receiving, by the computer, feedback from the specific user. The computer-implemented method further includes training, by the computer, the second ML model of the set of ML models based on the feedback.

In various embodiments of the disclosure, the computer-implemented method further includes obtaining, by the computer, historical transaction data that includes a classified set of historical transactions associated with a set of users. Each historical transaction of the classified set of historical transactions is classified into the at least one category of the set of categories. The specific user is excluded from the set of users. The computer-implemented method further includes obtaining, by the computer, one or more historical financial holdings associated with the set of users. The computer-implemented method further includes determining, by the computer, a training dataset based on the historical transaction data and the one or more historical financial holdings. The computer-implemented method further includes training, by the computer, the second ML model of the set of ML models based on the training dataset.

In various embodiments of the disclosure, the one or more financial holdings include one or more immovable assets associated with the specific user, one or more bank accounts associated with the specific user, one or more investments associated with the specific user, jewelry information associated with the specific user, and one or more loans associated with the specific user.

According to one or more embodiments of the disclosure, a computer system for the determination of unclaimed assets using machine learning (ML) models is described. The computer system includes a processor set, one or more computer-readable storage media, and program instructions stored on the one or more computer-readable storage media. The program instructions are executable by the processor set and cause the processor set to receive transaction data that includes a set of transactions associated with a first bank account of a specific user. The program instructions further cause the processor set to apply a first machine learning (ML) model of a set of ML models to the transaction data. The program instructions further cause the processor set to classify each transaction of the set of transactions into at least one category of a set of categories based on the application of the first ML model to the transaction data. The program instructions further cause the processor set to apply a second ML model of the set of ML models to the classified set of transactions. The program instructions further cause the processor set to determine one or more financial holdings associated with the specific user based on the application of the second ML model to the classified set of transactions. The program instructions further cause the processor set to generate a wealth portfolio catalog associated with the specific user based on the determination of the one or more financial holdings. The program instructions further cause the processor set to output the generated wealth portfolio catalog.

In various embodiments of the disclosure, the set of categories includes a deposit category, a loan category, an investments category, a real estate category, a jewelry category, and a transfer category. The transfer category is associated with a transfer of funds from the first bank account of the specific user to a second bank account of the specific user.

In various embodiments of the disclosure, the program instructions further cause the processor set to obtain a set of dictionaries associated with the determined one or more financial holdings. The program instructions further cause the processor to apply the first ML model of the set of ML models to the set of dictionaries. The program instructions further cause the processor to determine a set of features associated with each financial holding of the one or more financial holdings based on the application of the first ML model to the set of dictionaries. The program instructions further cause the processor to generate the wealth portfolio catalog associated with the specific user based on the determination of the set of features.

In various embodiments of the disclosure, the set of features includes a first feature associated with a price value of each financial holding of the one or more financial holdings, a second feature associated with a maturity amount of each financial holding of the one or more financial holdings, and a third feature associated with a payment schedule of each financial holding of the one or more financial holdings.

In various embodiments of the disclosure, the program instructions further cause the processor set to extract one or more key identifiers associated with each transaction of the set of transactions based on the transaction data. Each identifier of the one or more identifiers is associated with a corresponding transaction of the set of transactions. The program instructions further cause the processor to apply the first ML model of the set of ML models to the one or more key identifiers. The program instructions further cause the processor to classify each transaction of the set of transactions into the at least one category of the set of categories based on the application of the first ML model to the one or more key identifiers.

In various embodiments of the disclosure, the one or more key identifiers include a monetary value associated with each transaction of the set of transactions, a transaction date associated with each transaction of the set of transactions, timestamp data associated with each transaction of the set of transactions, payee data associated with each transaction of the set of transactions, payer data associated with each transaction of the set of transactions, transaction remarks associated with each transaction of the set of transactions, and a transaction code associated with each transaction of the set of transactions.

In various embodiments of the disclosure, the program instructions further cause the processor set to identify one or more recurring transactions from the set of transactions based on the transaction data. The program instructions further cause the processor to classify each transaction of the set of transactions into the at least one category of the set of categories based on the identification of one or more recurring transactions.

In various embodiments of the disclosure, the one or more financial holdings include one or more immovable assets associated with the specific user, one or more bank accounts associated with the specific user, one or more investments associated with the specific user, jewelry information associated with the specific user, and one or more loans associated with the specific user.

According to one or more embodiments of the disclosure, a computer-program product for the determination of unclaimed assets using machine learning (ML) models is described. The computer program product includes one or more computer-readable storage media and program instructions stored in the one or more computer-readable storage media to perform operations that include receiving transaction data that includes a set of transactions associated with a first bank account of a specific user. The operations further include applying a first machine learning (ML) model of a set of ML models to the transaction data. The operations further include classifying each transaction of the set of transactions into at least one category of a set of categories based on the application of the first ML model to the transaction data. The operations further include applying a second ML model of the set of ML models to the classified set of transactions. The operations further include determining one or more financial holdings associated with the specific user based on the application of the second ML model to the classified set of transactions. The operations further include generating a wealth portfolio catalog associated with the specific user based on the determination of the one or more financial holdings. The operations further include outputting the generated wealth portfolio catalog.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

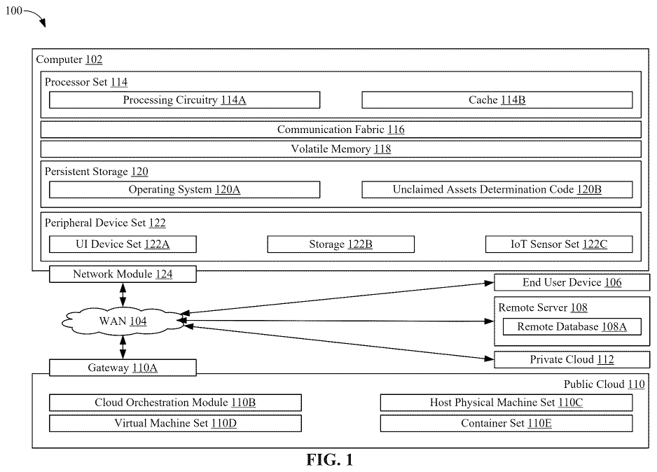

FIG. 1 is a diagram that illustrates a computing environment for determination of unclaimed assets using machine learning (ML) models, in accordance with an embodiment of the disclosure. With reference to FIG. 1, there is shown a computing environment 100 that contains an example of an environment for the execution of at least some of the computer code involved in performing the disclosed methods, such as an unclaimed assets determination code 120B. In addition to the unclaimed assets determination code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the determination code 120B for the unclaimed assets, as identified above), a peripheral device set 122 (including a user interface (UI) device set 122A, a storage 122B, and an Internet of Things (IOT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods may be stored in the dynamic modification of the unclaimed assets determination code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the unclaimed assets determination code 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

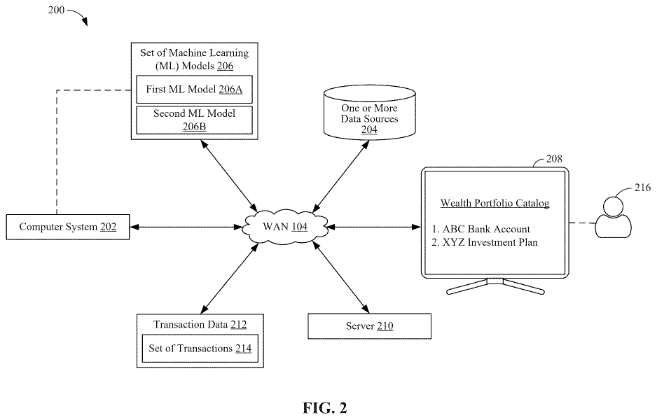

FIG. 2 is a diagram that illustrates an environment for determination of unclaimed assets using machine learning (ML) models, in accordance with an embodiment of the disclosure. FIG. 2 is explained in conjunction with elements from FIG. 1. With reference to FIG. 2, there is shown a diagram of a network environment 200. The network environment 200 includes a computer system 202, one or more data sources 204, and a set of Machine Learning (ML) models 206. The set of ML models 206 includes a first ML model 206A and a second ML model 206B. The network environment 200 further includes a user device 208, a server 210, and transaction data 212 that includes a set of transactions 214. The network environment 200 further includes a specific user 216 associated with the user device 208. The network environment 200 further includes the WAN 104 of FIG. 1. In an embodiment of the disclosure, the user device 208 is an exemplary embodiment of the EUD 106. Similarly, the computer system 202 is an exemplary embodiment of the computer 102 in FIG. 1.

The computer system 202 includes suitable logic, circuitry, and/or interfaces for determination of unclaimed assets using ML models. The computer system 202 receives the transaction data 212 that includes the set of transactions 214 associated with a first bank account of a specific user 216. The computer system 202 receives the transaction data 212 from the one or more data sources 204. The computer system 202 further applies the first ML model 206A of the set of ML models 206 to the transaction data 212. The computer system 202 further classifies each transaction of the set of transactions 214 into at least one category of the set of categories based on the application of the first ML model 206A to the transaction data 212. The computer system 202 further applies the second ML model 206B of the set of ML models 206 to the classified set of transactions. The computer system 202 further determines one or more financial holdings associated with the specific user 216 based on the application of the second ML model 206B to the classified set of transactions. The computer system 202 further generates the wealth portfolio catalog associated with the specific user 216 based on the determination of the one or more financial holdings. The computer system 202 further outputs the wealth portfolio catalog.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the computer system 202 may be embodied as a cloud-based service, a cloud-based application, a cloud-based platform, a remote server-based service, a remote server-based application, a remote server-based platform, or a virtual computing system.

Each data source of the one or more data sources 204 corresponds to an organized collection of data that may be stored and accessed electronically from a computer system (such as the computer system 202). Each of the one or more data sources 204 may be designed to manage, store, retrieve, and update data efficiently. In an exemplary implementation, each data source of the one or more data sources 204 may correspond to a database. In such an implementation, the structure of the database corresponding to each data source of the one or more data sources 204 typically involves tables, records, and fields that can be managed through various database management systems (DBMS).

In an embodiment of the disclosure, each data source of the one or more data sources 204 stores the transaction data 212. The transaction data 212 includes the set of transactions 214 associated with the first bank account of the user. Specifically, the one or more data sources 204 are connected with the application programming interfaces (APIs) of a specific bank under which the first bank account of the user is registered. Examples of each data source of one or more data sources 204 may include, but are not limited to, a relational database, a Non-Structured Query Language (SQL) database, a hierarchical database, a network database, a transactional database, a data warehouse, and a distributed database.

The first ML model 206A of the set of ML models 206 may be a sophisticated piece of software that leverages natural language processing (NLP) and machine learning techniques to understand, generate, and manipulate human language. For example, the first ML model 206A of the set of ML models 206 may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. For example, the LLM model for language processing may be implemented using GPT, Bidirectional Encoder Representations from Transformers (BERT), and the like.

Further, the LLM may be a type of ML model specifically designed to understand, generate, and manipulate human language on a large scale. LLMs may leverage machine learning techniques, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

For example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts.

The LLMs are majorly used to perform language-related tasks, such as sentiment analysis, text classification, question answering, machine translation, summarization, and conversational agents. Due to a large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications.

It may be noted that a base model in an LLM refers to a trained model that has been trained on a large corpus of data for a general natural language understanding and generation task. The trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

For example, the base model contains a large number of parameters and exhibits a high level of language understanding, making it a powerful starting point for a variety of natural language processing tasks. While the base model is pre-trained on a large corpus of general language data, fine-tuning or adapting the base model for specific tasks or domains enhances its performance and makes it more suitable for targeted applications.

Continuing further, an adapter refers to a smaller and task-specific module added to the base model to adapt the base model for a particular task or domain. The adapter includes a lightweight set of parameters that is trained on task-specific data while keeping all or the majority of the base model's parameters frozen. In particular, the adapter is used to fine-tune the base model for a specific downstream task without extensively modifying its pre-trained parameters. This approach is beneficial when computational resources or labeled task-specific data are limited.

In an embodiment of the disclosure, the first ML model 206A of the set of ML models 206 classifies each transaction of the set of transactions 214 into at least one category of the set of categories. In an embodiment of the disclosure, the first ML model 206A of the set of ML models 206 analyzes the patterns and the relationships in the transaction data 212 based on its training data and classifies each transaction of the set of transactions 214 into at least one category of the set of categories. In an embodiment of the disclosure, the computer system 202 stores the first ML model 206A of the set of ML models 206. In an alternate embodiment of the disclosure, the first ML model 206A of the set of ML models 206 is embodied as a cloud-based service, a cloud-based application, or a cloud-based platform. Examples of the first ML model 206A of the set of ML models 206 include one of but are not limited to, a generative pre-trained transformer (GPT) model, a bidirectional encoder representations from transformers (BERT) model, and the like.

The second ML model 206B of the set of ML models 206 corresponds to a neural network-based regression model. The neural network is a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, the inputs of each hidden layer are coupled to outputs of at least one node in other layers of the neural network. Outputs of each hidden layer may be coupled to inputs of at least one node in other layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on the training dataset. Each node of the neural network corresponds to a mathematical function (e.g., a sigmoid 2 function or a rectified linear unit) with a set of parameters, tunable during the training of the neural network. The set of parameters includes, for example, a weight parameter, a regularization parameter, and the like. Each node uses the mathematical function to compute an output based on one or more inputs from nodes in other layer(s) (e.g., previous layer(s)) of the neural network. All or some of the nodes of the neural network correspond to the same or a different mathematical function.

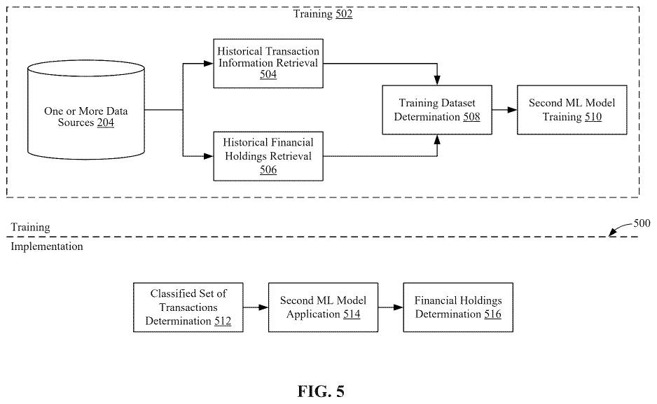

In the training of the second ML model 206B of the set of ML models 206, one or more parameters of each node of the second ML model 206B of the set of ML models 206 may be updated based on whether an output of the final layer for a given input (from the training dataset) matches a correct result based on a loss function for the second ML model 206B of the set of ML models 206. The above process may be repeated for the same or a different input until a minima of loss function may be achieved, and a training error may be minimized. Details related to the training of the second ML model 206B of the set of ML models 206 are provided in, for example, in FIG. 5 and its corresponding description.

The neural network includes electronic data, such as, for example, a software program, code of the software program, libraries, applications, scripts, or other logic or instructions for execution by a processing device, such as circuitry. The neural network may be implemented using hardware including a processor, a microprocessor (e.g., to perform or control the performance of one or more operations), a field-programmable gate array (FPGA), or an application-specific integrated circuit (ASIC). Alternatively, in some embodiments, the neural network may be implemented using a combination of hardware and software. Accordingly, in some embodiments, the second ML model 206B of the set of ML models 206 is a separate entity in the computer system 202, without deviation from the scope of the disclosure.

In an embodiment of the disclosure, the second ML model 206B of the set of ML models 206 determines the one or more financial holdings associated with the user based on the classified set of transactions 214. In an embodiment of the disclosure, the second ML model 206B of the set of ML models 206 determines a set of features associated with the one or more financial holdings associated with the user. In an embodiment of the disclosure, the computer system 202 trains the second ML model 206B of the set of ML models 206 to determine the one or more financial holdings associated with the user and the set of features associated with the one or more financial holdings. Details about the training of the second ML model 206B of the set of ML models 206 are provided, for example, in FIG. 5.

In an embodiment of the disclosure, the computer system 202 stores the second ML model 206B of the set of ML models 206. In an alternate embodiment of the disclosure, the second ML model 206B of the set of ML models 206 is embodied as a cloud-based service, a cloud-based application, or a cloud-based platform. Examples of the second ML model 206B of the set of ML models 206 include one of but are not limited to, an artificial neural network (ANN), a deep neural network (DNN), a convolutional neural network (CNN), a fully connected neural network, and/or a combination of such networks.

The user device 208 includes suitable logic, circuitry, and/or interfaces that are configured to execute one or more tasks within the network environment 200. The user device 208 performs the one or more tasks such as receiving data, processing the data, and transmitting the data. In an embodiment of the disclosure, the computer system 202 renders the wealth portfolio catalog on the user device 208. Examples of the user device 208 may include but are not limited to, a smartphone, a cellular phone, a mobile phone, a consumer electronic (CE) device, an Internet of Things (IOT) device, a computing device, a mainframe machine, a server, a computer workstation, or the like.

The server 210 includes suitable logic, circuitry, interfaces, and/or code that stores the transaction data 212 and the predefined set of key identifiers. The server 210 stores the first ML model 206A, and the second ML model 206B. The server 210 can be implemented as a cloud server and may execute operations through web applications, cloud applications, HTTP requests, repository operations, file transfer, and the like. Other example implementations of the server 210 include but are not limited to, a database server, a file server, a web server, a media server, an application server, a mainframe server, or a cloud computing server.

In an embodiment of the disclosure, the server 210 is implemented as a plurality of distributed cloud-based resources by use of several technologies that are well known to those ordinarily skilled in the art. A person with ordinary skill in the art will understand that the scope of the disclosure may not be limited to the implementation of the server 210 and the computer system 202 as two separate entities. In certain embodiments, the functionalities of the server 210 can be incorporated in its entirety or at least partially in the computer system 202, without a departure from the scope of the disclosure.

In operation, the computer system 202 receives the transaction data 212 from the one or more data sources 204. The transaction data 212 includes the set of transactions 214 associated with the first bank account of the specific user 216. In an embodiment of the disclosure, the computer system 202 receives the transaction data 212 that includes the set of transactions 214 associated with the first bank account of the specific user 216 from the one or more data sources 204. In an embodiment of the disclosure, the one or more data sources 204 are connected with a specific bank via the application programming interfaces (APIs) of the specific bank under which the bank account of the specific user 216 is registered. In such an implementation, the computer system 202 obtains the transaction data via the API calls.

In an embodiment, the transaction data 212 includes transaction identifier of each transaction of the set of transactions 214, a transaction date associated with each transaction of the set of transactions 214, timestamp data associated with each transaction of the set of transactions 214, a monetary value associated with each transaction of the set of transactions 214, payer data associated with each transaction of the set of transaction, payee data associated with each transaction of the set of transactions 214, transaction remarks associated with each transaction of the set of transactions 214, and a transaction code associated with each transaction of the set of transactions 214. The transaction identifier indicates a unique identifier of a corresponding transaction (the transaction id) of the set of transactions 214. For example, the transaction identifier associated with a specific transaction is “XXX243”. The transaction date and the timestamp data indicate the date and the time, respectively, at which the corresponding transaction is performed. For example, a specific transaction is performed on “27 Jan. 2023” and at “5:00 PM”. The monetary value indicates the transfer of the amount involved in the corresponding transaction of the set of transactions 214. For example, the monetary value associated with a specific transaction is “$25000”. The payer data indicates the data associated with the sender of the corresponding transaction of the set of transactions 214. For example, the payer data associated with a specific transaction includes at least the name of the sender as “User X1”.

The payee data indicates the data associated with the recipient of monetary value of the corresponding transaction. For example, the payee data associated with a specific transaction indicates at least the name of the recipient as “User X2”. The transaction remarks include a message associated with the corresponding transaction of the set of transactions 214. For example, if the message associated with a specific transaction includes “gold purchase”, then the transaction remarks indicate that the specific transaction is associated with a jewelry purchase. The transaction code indicates the purpose of the corresponding transaction of the set of transactions 214. By way of example, and not by limitation, if the transaction code associated with a specific transaction includes a specific identifier, “Federal Housing Administration (FHA)”, then the specific transaction indicates that the purpose of the specific transaction is associated with a home loan.

By way of example, and not by limitation, the transaction data 212 includes 5 transactions (transaction A, transaction B, transaction C, transaction D, and transaction E) associated with the user. Transaction A is a debit of $600 from the bank account of “User X1” on “11 Aug. 2023” and the transaction code associated with transaction A includes the specific identifier “FHA”. Transaction B is a debit of $400 from the bank account of transaction B on “10 Feb. 2023” and the transaction code includes the specific identifier “Depository Trust & Clearing Corporation (DTCC)” which indicates that the purpose of the specific transaction is a Systematic Investment Plan (SIP). Transaction C is a debit of $600000 from the bank account of “User X1” to the bank account of “PQR Real Estate Solutions” on “11 Jan. 2022”. PQR Real Estate Solutions is registered under the specific bank as a property dealer and deals with the sales and purchase of property in Location A1. The transaction remark associated with transaction C includes the message “700 square feet real estate”. Transaction D includes a debit of $25000 from the bank account of “User X1” to the bank account of “User X2” on “15 Sep. 2022”. “User X2” is a nominee of “User X1” and registered as the brother of “User X1” under the specific bank. Transaction E is a debit of $50000 from the bank account of “User X1” to the bank account of “ABC jewelers” on “1 Oct. 2022”. ABC jewelers is registered under the specific bank as a well-known jeweler. The transaction remark associated with transaction E includes the message “gold purchase”.

Thereafter, the computer system 202 applies the first ML model 206A of the set of ML models 206 to the transaction data 212. The first ML model 206A of the set of ML models 206 analyzes the patterns and relationships within the transaction data 212 based on its training data. In an embodiment of the disclosure, the first ML model 206A of the set of ML models 206 performs text analysis of the transaction data 212 that includes the set of transactions 214. Specifically, the first ML model 206A of the set of ML models 206 analyzes the monetary value involved in each transaction of set of transactions 214, the transaction date associated with each transaction of the set of transactions 214, the timestamp data associated with each transaction of the set of transactions 214, the payee data associated with each transaction of the set of transactions 214, the payer data of each transaction of the set of transactions 214, the transaction remarks associated with each transaction of the set of transactions 214, and the transaction code associated with each transaction of the set of transactions 214. Based on the analysis, the first ML model 206A identifies the patterns and relationships between each transaction of the set of transactions 214 based on its training data.

By way of example, and not by limitation, the computer system 202 applies the first ML model 206A of the set of ML models 206 to the transaction data 212 that includes the 5 transactions (transaction A, transaction B, transaction C, transaction D, and transaction E). The first ML model 206A of the set of ML models 206 analyzes the transaction code associated with transaction A (“FHA”) which indicates that transaction A is associated with a home loan. The first ML model 206A of the set of ML models 206 further analyzes the transaction code associated with transaction B “DTCC” that indicates the purpose of transaction B is a systematic investment plan (SIP). The first ML model 206A of the set of ML models 206 further analyzes the transaction remark associated with transaction C that includes the message “700 square feet real estate”. The first ML model 206A of the set of ML models 206 further analyzes the payee data associated with the transaction D that includes the name of the payee “User X2”, who is the nominee of “User X1” and registered as the brother of “User X1” under the specific bank. The first ML model 206A of the set of ML models 206 further analyzes the transaction remark associated with transaction E that includes the message “gold purchase”.

Further, the computer system 202 classifies each transaction of the set of transactions 214 into the at least one category of the set of categories based on the application of the first ML model 206A to the transaction data. In an embodiment of the disclosure, the first ML model 206A of the set of ML models 206 performs text classification based on the transaction data. In an embodiment of the disclosure, the set of categories includes a deposit category, a loan category, an investments category, a real estate category, a jewelry category, and a transfer category.

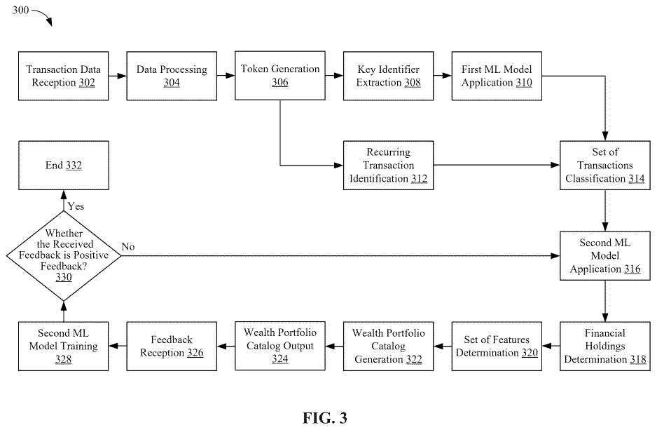

By way of example, and not by limitation, the computer system 202 obtains a set of predefined transaction codes from the one or more data sources 204. The set of predefined transaction codes includes a first transaction code “Depository Trust & Clearing Corporation (DTCC)” that indicates the investment category, a second transaction code “Federal Housing Administration (FHA)” that indicates a loan category, and a third category “Automated Clearing House (ACH)” that indicates a transfer category. The first ML model 206A of the set of ML models 206 further analyzes the transaction code associated with each transaction of the set of transactions 214 and classifies each transaction of the set of transactions 214 into the at least one category of the set of categories based on the set of predefined transaction codes. Details about the set of transactions classification are provided, for example, in FIG. 3.

By way of example, and not by limitation, the computer system 202 classifies each transaction of the set of transactions 214 into the at least one category of the set of categories. The computer system 202 classifies transaction A including the transaction code “FHA” into the loan category based on the application of the first ML model 206A of the set of ML models 206. The computer system 202 further classifies transaction B which includes the transaction code “DTCC” into the investment category. The computer system 202 further classifies transaction C including the transaction remarks “700 square feet real estate” into the real estate category. In an embodiment of the disclosure, the first ML model further performs text analysis of the transaction remarks associated with transaction C that includes the message “700 square feet real estate” to classify transaction C into the real estate category. The computer system 202 further classifies transaction D including the payee data “User X2” into the transfer category. The computer system 202 further classifies transaction E which includes the transaction remarks “gold purchase” into the jewelry category. In an embodiment of the disclosure, the first ML model further performs text analysis of the transaction remarks associated with transaction C that includes the message “gold purchase” to classify transaction E into the jewelry category.

Thereafter, the computer system 202 applies the second ML model 206B of the set of ML models 206 to the classified set of transactions 214. The second ML model 206B is trained to determine the one or more financial holdings based on the classified set of transactions 214. In an embodiment of the disclosure, the second ML model 206B of the set of ML models 206 analyzes the patterns and relationships within the classified set of transactions 214 based on its training data and determines the one or more financial holdings. The one or more financial holdings represent an individual or entity's assets and liabilities. The assets include items of value such as cash, investments, property (real estate), jewelry, and the like. Liability refers to debts such as loans and mortgages. The one or more financial holdings provides insight into net worth, liquidity, and overall financial health. Details about the training of the second ML model 206B of the set of ML models 206 are provided, for example, in FIG. 5.

By way of example, and not by limitation, the computer system 202 applies the second ML model 206B of the set of ML model 206 to the classified set of transactions 214 that includes the classified transaction A (classified into the loan category), the classified transaction B (classified into the investment category), the classified transaction C (classified into the real estate category), the classified transaction D (classified into the transfer category), and the classified transaction E (classified into the jewelry category). The second ML model 206B of the set of ML models 206 analyzes the patterns and relationships between the classified set of transactions 214 based on its training data and determines the one or more financial holdings.

Further, the computer system 202 determines the one or more financial holdings associated with the specific user 216 based on the application of the second ML model 206B to the classified set of transactions 214. In an embodiment of the disclosure, the one or more financial holdings include one or more immovable assets associated with the specific user 216, a second bank account associated with the specific user 216, one or more investments associated with the specific user 216, jewelry information associated with the specific user 216, and one or more loans associated with the specific user 216. Details about the one or more financial holdings determination are further provided, for example, in FIG. 3.

By way of example, and not by limitation, the computer system 202 determines the one or more financial holdings associated with “User X1” based on the application of the second ML model 206B to the classified set of transactions 214 that includes the classified transaction A (classified into the loan category), the classified transaction B (classified into the investment category), the classified transaction C (classified into the real estate category), the classified transaction D (classified into the transfer category), and the classified transaction E (classified into the jewelry category).

The computer system 202 determines five financial holdings associated with “User X1”. The computer system 202 determines the home loan X which “User X1” had borrowed. The computer system 202 determines a SIP investment plan Y in which “User X1” had invested. The computer system 202 further determines a 700 square feet real estate property (for example property Z) associated with “User X1”. The computer system 202 further determines an alternate bank account of “User X2” associated with “User X1”, who is the brother and nominee of “User X1”. The computer system 202 further determines gold jewelry (for example jewelry W) associated with “User X1”.

Further, the computer system 202 generates the wealth portfolio associated with the specific user 216 based on the determination of the one or more financial holdings. The wealth portfolio catalog includes the one or more financial holdings associated with the specific user 216. The wealth portfolio catalog is a structured collection of the one or more financial holdings that represent an individual or entity's financial holdings. The wealth portfolio catalog includes all assets, such as cash, investments, property (real estate), jewelry, and the like of the specific user 216. The wealth portfolio catalog also includes liabilities, like loans and debts.

By way of example, and not by limitation, the computer system 202 generates the wealth portfolio catalog associated with “User X1” based on the determination of the one or more financial holdings associated with “User X1”. The wealth portfolio catalog associated with “User X1” includes the one or more financial holdings associated with “User X1” and can be represented in Table 1 given below:

TABLE 1
Wealth Portfolio Catalog associated with User X1
Wealth Portfolio Catalog

| | | |
|---|---|---|
| 1. | Bank Accounts | XYZ241 - User X2 (Brother) |
| 2. | Immovable Assets | Property Z |
| 3. | Jewelry | Jewelry W |
| 4. | Investment | SIP Investment Plan Y |
| 5. | Loan | Home Loan X |

To this end, the computer system 202 outputs the generated wealth portfolio catalog. In an embodiment of the disclosure, the computer system 202 renders the generated wealth portfolio catalog on the user device 208. In an embodiment of the disclosure, the computer system 202 performs the determination of the one or more financial holdings and the generation of the wealth portfolio catalog by analyzing the transaction data 212. The real-time tracking of user investments is a time-consuming and tedious task that requires high-end computing resources. The computer system 202 does not require real-time tracking of investments made by the specific user 216, which reduces the overall computer processing time of the computer system 202 for the determination of one or more financial holdings. The computer system 202 further eliminates the need for high-end computing resources for the determination of the one or more financial holdings. The need for these high-end computational resources increases the overall cost of the determination of the one or more financial holdings. Hence, the computer system reduces the overall cost of the process of determination of the one or more financial holdings. Moreover, the computer system 202 determines the one or more investments and the one or more loans (digital assets) as well as the one or more immovable assets and the jewelry information (non-digital assets).

FIG. 3 is a diagram that illustrates exemplary operations for determination of unclaimed assets using machine learning (ML) models, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 332, as described herein. The exemplary operations illustrated in the block diagram 300 start at 302 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 300 can be divided into additional blocks, combined into fewer blocks, or eliminated, depending on the implementation.

At 302, a transaction data retrieval operation is performed. In the transaction data retrieval operation, the computer system 202 receives the transaction data 212 from the one or more data sources 204. The transaction data 212 includes the set of transactions 214 associated with the first bank account of the specific user 216. In an embodiment of the disclosure, the computer system 202 receives the transaction data 212 that includes the set of transactions 214 associated with the first bank account of the specific user 216 from the one or more data sources 204. In an embodiment of the disclosure, the one or more data sources 204 are connected with a specific bank via the application programming interfaces (APIs) of the specific bank under which the bank account of the specific user 216 is registered. In such an implementation, the computer system 202 obtains the transaction data via the API calls.

At 304, a data processing operation is performed. In the data processing operation, the computer system 202 applies one or more data processing techniques to the transaction data 212. In an embodiment of the disclosure, the computer system 202 applies the one or more data processing techniques to increase the quality of the transaction data 212 and to ensure that the transaction data 212 is accurate and standardized for further analysis. In an embodiment of the disclosure, the one or more data processing techniques include an imputation-based data cleaning technique and a normalization technique.

In an embodiment of the disclosure, the computer system 202 applies the imputation-based data cleaning technique to the transaction data 212. In an embodiment of the disclosure, the computer system 202 identifies one or more missing values in the transaction data 212. The one or more missing values correspond to various fields in the transaction data 212 where discontinuities are present (or the values are absent). In an embodiment of the disclosure, the computer system 202 identifies one or more transactions from the set of transactions that includes the one or more missing values, such as one or more missing transaction remarks in the transaction data 212. The computer system 202 further applies the first ML model 206A of the set of ML models to the one or more transactions of the set of transactions 214. The first ML model 206A analyzes the transaction code associated with the one or more transactions and generates the one or more transaction remarks for the one or more transactions. The computer system 202 further substitutes the generated one or more transaction remarks in the transaction data 212.

In an alternate embodiment of the disclosure, the computer system 202 applies the normalization technique to the transaction data 212. In an embodiment of the disclosure, the computer system 202 normalizes the transaction data 212 to ensure that the transaction data 212 is standardized. By way of example, and not by limitation, if the transaction data 212 includes one or more transactions in which the transaction amounts are in two different currencies (such as dollars and euros), then the computer system 202 applies the normalization technique to convert them into a single currency (dollars). The computer system 202 obtains a conversion factor to convert two currencies into a single currency (dollars) from the one or more data sources 204. The computer system 202 further converts the two currencies into a single currency (dollars) based on the conversion factor to ensure that the transaction data 212 is in a standardized format for further analysis.

At 306, a token generation operation is performed. In the token generation operation, the computer system 202 generates one or more tokens. In an embodiment of the disclosure, the computer system 202 generates the one or more tokens associated with the set of transactions 214 based on the application of the one or more data processing techniques to the transaction data 212. Each token of the one or more tokens is associated with the corresponding transaction of the set of transactions 214. Each token of the one or more tokens is a unique identifier or symbol which is used to represent the corresponding transaction within the set of transactions 214. In an embodiment of the disclosure, each token of the set of tokens serves as a unique identifier for the corresponding transaction of the set of transactions 214. Therefore, the computer system 202 generates the one or more tokens to uniquely identify each transaction of the set of transactions 214 instead of analyzing the transaction identifier (transaction ID) to reduce the processing time for the set of transactions 214 for further analysis.

At 308, a key identifier extraction operation is performed. In the key identifier extraction operation, the computer system 202 extracts the one or more key identifiers associated with each transaction of the set of transactions 214 based on the transaction data 212. In an embodiment of the disclosure, the computer system 202 extracts the one or more key identifiers based on the generation of the one or more tokens. In an embodiment of the disclosure, each key identifier of the one or more key identifiers is associated with the corresponding transaction of the set of transactions 214. Each key identifier of the one or more key identifiers refers to an attribute or combination of attributes that uniquely distinguishes a specific transaction within the set of transactions 214. The one or more key identifiers serve to facilitate tracking, verification, and record-keeping, enabling proper management of each transaction of the set of transactions 214 while ensuring their uniqueness and integrity. The one or more key identifiers provide an in-depth information about each transaction of set of transactions 214 whereas the one or more tokens are only used as a parameter to uniquely identify each transaction of the set of transactions 214. For example, the one or more key identifiers provide information about the monetary value associated with each transaction of the set of transactions 214, transaction remarks associated with each transaction of the set of transactions 214, and the like.

In an embodiment of the disclosure, the one or more key identifiers include a combination of the monetary value associated with each transaction of the set of transactions 214, a transaction date associated with each transaction of the set of transactions 214, timestamp data associated with each transaction of the set of transactions 214, payee data associated with each transaction of the set of transactions 214, payer data associated with each transaction of the set of transactions 214, transaction remarks associated with each transaction of the set of transactions 214, and a transaction code associated with each transaction of the set of transactions 214.

The transaction date and the timestamp data indicate the date and the time, respectively, at which the corresponding transaction is performed. For example, a specific transaction is performed on “27 Jan. 2002” and at “5:00 PM”. The monetary value indicates the transfer of the amount involved in the corresponding transaction of the set of transactions 214. For example, the monetary value associated with a specific transaction is “$25000”. The payer data indicates the data associated with the sender of the corresponding transaction of the set of transactions 214. For example, the payer data associated with a specific transaction includes at least the name of the sender as “User Y1”.

The payee data indicates the data associated with the recipient of the corresponding transaction of the set of transactions 214. For example, the payee data associated with a specific transaction indicates at least the name of the recipient as “User Y2”. The transaction remarks include a message associated with the corresponding transaction of the set of transactions 214. For example, if the message associated with a specific transaction includes “gold purchase”, then the transaction remarks indicate that the specific transaction is associated with a jewelry purchase. The transaction code indicates the purpose of the corresponding transaction of the set of transactions 214. By way of example, and not by limitation, if the transaction code associated with a specific transaction includes a specific identifier, “FHA”, then the specific transaction indicates that the purpose of the specific transaction is associated with a home loan. In an embodiment of the disclosure, the computer system 202 extracts the date, the timestamp, the monetary value, the payer data, the payee data, the transaction remarks, and the transaction code associated with the corresponding transaction of the set of transactions 214 based on the transaction data.

By way of example, and not by limitation, transaction data 212 includes 10 transactions (transaction A, transaction B, transaction C, transaction D, transaction E, transaction F, transaction G, transaction H, transaction I, and transaction J) associated with the user. Transaction A is a debit of $500 from the bank account of “User Y1” on “15 Feb. 2023” and the transaction code associated with transaction A includes the specific identifier “FHA”. Transaction B is a debit of $250 from the bank account of transaction B on “10 Feb. 2023” and the transaction code includes the specific identifier “DTCC” which indicates that the purpose of the specific transaction is a Systematic Investment Plan (SIP). Transaction C is a debit of $500000 from the bank account of “User Y1” to the bank account of “PQR Real Estate Solutions” on “1 Jan. 2020”. PQR Real Estate Solutions is registered under the specific bank as a property dealer and deals with the sales and purchase of property in Location A2. The transaction remark associated with transaction C includes the message “800 square feet real estate”. Transaction D is a debit of $500 from the bank account of “User Y1” on “15 Mar. 2023” and the transaction code associated with transaction D includes the specific identifier “FHA”. Transaction E is a debit of $250 from the bank account of transaction B on “10 Mar. 2023” and the transaction code includes the specific identifier “DTCC” which indicates that the purpose of the specific transaction is a Systematic Investment Plan (SIP). Transaction F includes a debit of $25000 from the bank account of “User Y1” to the bank account of “User Y2” on “15 Sep. 2020”. “User Y2” is a nominee of “User Y1” and registered as the wife of “User Y1” under the specific bank. Transaction G is a debit of $50000 from the bank account of “User Y1” to the bank account of “ABC jewelers” on “1 Oct. 2020”. ABC jewelers is registered under the specific bank as a well-known jeweler. The transaction remark associated with transaction G includes the message “gold purchase”. Transaction H is a debit of $500 from the bank account of “User Y1” on “15 Apr. 2023” and the transaction code associated with transaction H includes the specific identifier “FHA”. Transaction I is a debit of $250 from the bank account of transaction B on “10 Apr. 2023” and the transaction code includes the specific identifier “DTCC” which indicates that the purpose of the specific transaction is a systematic investment plan (SIP). Transaction J includes a debit of $10000 from the bank account of “User Y1” to the bank account of “User Y3” on “15 Dec. 2022”. “User Y2” is registered as the brother of “User Y1” under the specific bank. In an embodiment of the disclosure, the computer system 202 extracts the one or more key identifiers associated with each transaction (transaction A, transaction B, transaction C, transaction D, transaction E, transaction F, transaction G, transaction H, transaction I, and transaction J) associated with the user. The transaction data associated with “User Y1” can be represented in the Table 2 shown below:

TABLE 2
Transaction Data Associated with “User Y1”

| | | | Transaction | | Transaction |
|---|---|---|---|---|---|
| Transactions | Amount | Payee | Code | Date | Remarks |
| A | $500 | | FHA | 15 Feb. 2023 | |
| B | $250 | | DTCC | 10 Feb. 2023 | |
| C | $500000 | PQR Real Estate | ACH | 1 Jan. 2020 | “800 sq. feet |
| | | Solutions | | | real estate” |
| D | $500 | | FHA | 15 Mar. 2023 | |
| E | $250 | | DTCC | 10 Mar. 2023 | |
| F | $25000 | User Y2 | ACH | 15 Sep. 2020 | |
| G | $50000 | ABC jewelers | ACH | 1 Oct. 2020 | “gold |
| | | | | | purchase” |
| H | $500 | | FHA | 15 Apr. 2023 | |
| I | $250 | | DTCC | 10 Apr. 2023 | |
| J | $10000 | | ACH | 15 Dec. 2022 | |

At 310, a first ML model application operation is performed. In the first ML model application operation, the computer system 202 applies the first ML model 206A of the set of ML models 206 to the transaction data 212. The first ML model 206A of the set of ML models 206 analyzes the patterns and relationships within the transaction data 212 based on its training data. In an embodiment of the disclosure, the first ML model 206A of the set of ML models 206 analyzes the one or more key identifiers. In an embodiment of the disclosure, the first ML model 206A of the set of ML models 206 analyzes the monetary value associated with each transaction of set of transactions 214, the transaction date associated with each transaction of the set of transactions 214, the timestamp data associated with each transaction of the set of transactions 214, the payee data associated with each transaction of the set of transactions 214, the payer data associated with each transaction of the set of transactions 214, the transaction remarks associated with each transaction of the set of transactions 214, and the transaction code associated with each transaction of the set of transactions 214 and identifies the patterns and relationships between the set of transactions 214 based on its training data.

By way of example, and not by limitation, the computer system 202 applies the first ML model 206A of the set of ML models 206 to the transaction data 212 that includes the 10 transactions (transaction A, transaction B, transaction C, transaction D, transaction E, transaction F, transaction G, transaction H, transaction I and transaction J). The first ML model 206A of the set of ML models 206 analyzes the transaction code associated with transaction A (“FHA”) which indicates that transaction A is associated with a home loan. The first ML model 206A of the set of ML models 206 further analyzes the transaction code associated with transaction B “DTCC” that indicates the purpose of transaction B is a systematic investment plan (SIP). The first ML model 206A of the set of ML models 206 further analyzes the transaction remark associated with transaction C that includes the message “800 square feet real estate”. The first ML model 206A of the set of ML models 206 further analyzes the transaction code associated with transaction D which also includes (“FHA”) same as Transaction A and the monetary value ($500) which is also the same as Transaction A. The first ML model 206A of the set of ML models 206 further analyzes the transaction code associated with transaction E which also includes (“DTCC”), the same as Transaction B, and the monetary value ($250) which is also the same as Transaction B.

The first ML model 206A of the set of ML models 206 further analyzes the payee data associated with the transaction F includes the name of the payee “User Y2”, who is the nominee of “User Y1” and registered as the wife of “User Y1” under the specific bank. The first ML model 206A of the set of ML models 206 further analyzes the transaction remark associated with transaction G that includes the message “gold purchase”. The first ML model 206A of the set of ML models 206 further analyzes the transaction code associated with transaction H which also includes (“FHA”) same as Transaction A and the monetary value ($500) which is also the same as Transaction A. The first ML model 206A of the set of ML models 206 further analyzes the transaction code associated with transaction I which also includes (“DTCC”) the same as Transaction B and the monetary value ($250) which is also the same as Transaction B. The first ML model 206A of the set of ML models 206 further analyzes the payee data associated with transaction F that includes the name of the payee “User Y3”, who is registered as the brother of “User Y1” under the specific bank.

At 312, a recurring transaction identification operation is performed. In the recurring transaction identification operation, the computer system 202 identifies one or more recurring transactions. In an embodiment of the disclosure, the computer system 202 identifies the one or more recurring transactions from the set of transactions 214 based on the transaction data 212. In an embodiment of the disclosure, the computer system 202 identifies the one or more recurring transactions based on the generation of the one or more tokens. The one or more recurring transactions are the transactions in which the same transaction amount is transferred from the first bank account to a specific bank account (or for a single purpose such as loan interest payments) in fixed intervals of time. The one or more tokens can be used to uniquely identify each transaction of the set of transactions 214. The computer system 202 iterates each transaction of set of transactions 214 to identify the one or more recurring transactions.

In an embodiment of the disclosure, the computer system 202 iterates each transaction of the set of transactions 214 and identifies the one or more recurring transactions based on the monetary value, the transaction date, the timestamp data, the payee data, the payer data, the transaction remarks and the transaction code associated with the corresponding transaction of the set of transactions. The computer system 202 identifies a transaction pattern (or a pattern of payment) associated with the set of transactions 214 based on the one or more key identifiers associated with the set of transactions to identify the one or more recurring transactions.

By way of example, and not by limitation, the computer system 202 analyzes the one or more key identifiers associated with each transaction (transaction A, transaction B, transaction C, transaction D, transaction E, transaction F, transaction G, transaction H, transaction I and transaction J). The computer system 202 identifies that the transaction code associated with transaction D which also includes (“FHA”) same as Transaction A and the monetary value ($500) is also the same as Transaction A. The computer system 202 further identifies that the transaction date of the transaction D (“15 Mar. 2023”) is just one month after the transaction A (“15 Feb. 2023”). The computer system 202 identifies that transaction D is a recurring transaction of transaction A and identifies that transaction A and transaction D can be the interest payment of the Home Loan that “User Y1” had taken from the specific bank. Similarly, the computer system 202 further identifies that the transaction code associated with transaction H which also includes (“FHA”) same as Transaction A, and the monetary value ($500) is also the same as Transaction A. The transaction date of transaction H (“15 Apr. 2023”) is just two months after transaction A (“15 Feb. 2023”) and one month after transaction D (“15 Mar. 2023”), The computer system 202 identifies transaction H as recurring transaction of transaction A and transaction D.

The computer system 202 further identifies that the transaction code associated with transaction E which also includes (“DTCC”) the same as Transaction B and the monetary value ($250) which is also the same as Transaction B. The computer system 202 further identifies that the transaction date of the transaction E (“10 Mar. 2023”) is one month after the transaction B (“10 Feb. 2023”). The computer system 202 identifies that transaction E is a recurring transaction of transaction B and further determines that transaction E and transaction B may be the transactions associated with the investment plan in which “User Y1” had invested. Similarly, the computer system 202 further identifies that the transaction code associated with the transaction I also includes (“DTCC”) which is the same as Transaction B, and the monetary value ($250) is also the same as Transaction B. The transaction date of transaction I (“10 Apr. 2023”) is just two months after transaction B (“10 Feb. 2023”) and one month after transaction E (“10 Mar. 2023”), The computer system 202 identifies transaction I as recurring transaction of transaction B and transaction E.

At 314, a set of transactions classification operation is performed. In the set of transactions classification operation, the computer system 202 classifies the set of transactions into at least one category of the set of categories. In an embodiment of the disclosure, the computer system 202 classifies the set of transactions into the at least one category of the set of categories based on the application of the first ML model 206A to the one or more key identifiers. In an embodiment of the disclosure, the set of categories includes a deposit category, a loan category, an investments category, a real estate category, a jewelry category, and a transfer category.

The deposit category is a category that includes one or more transactions associated with fixed deposits and recurring deposits made to a specific bank account. The deposit category includes the one or more transactions in which a specified sum of money is placed into a specific bank account for a predetermined term at a designated interest rate, contributing to the overall balance of that account while typically restricting access to the principal amount until the maturity date. The loan category is a category that includes one or more transactions associated with loans disbursed to a specific bank account. The loan category includes the one or more transactions in which a specified amount of money is borrowed, typically under agreed-upon terms, such as interest rate and repayment schedule, impacting the overall balance of that account. Loans may include various types, such as personal loans, business loans, education loans, home loans, or the like, and are documented through loan agreements and account statements. The investment category is a category that includes one or more transactions associated with investments made to a specific bank account. The investment category includes the one or more transactions that involve the purchase and sale of various financial instruments, such as stocks, bonds, and mutual funds, which contribute to the overall financial portfolio linked to the specified bank account. The real estate category is a category that includes one or more transactions associated with the purchase, sale, or investment in real estate assets linked to a specific bank account. The real estate category includes the one or more transactions that involve residential, commercial, or land properties, which contribute to the overall asset portfolio of the account holder. The jewelry category is a category that includes one or more transactions associated with the acquisition or sale of jewelry items linked to a specific bank account. The jewelry category includes the one or more transactions that involve the purchase of gold, silver, precious stones, and other valuable adornments, contributing to the overall wealth portfolio of the account holder. The transfer category is associated with the transfer of funds from the first bank account associated with the user to a second bank account associated with the user.

By way of example, and not by limitation, the computer system 202 obtains a set of predefined transaction codes from the one or more data sources 204. The set of predefined transaction codes includes a first transaction code “Depository Trust & Clearing Corporation (DTCC)” that indicates the investment category, a second transaction code “Federal Housing Administration (FHA)” that indicates a loan category, and a third category “Automated Clearing House (ACH)” that indicates a transfer category. The first ML model 206A of the set of ML models 206 further analyzes the transaction code associated with each transaction of the set of transactions 214 and classifies each transaction of the set of transactions 214 into at least one category of the set of categories based on the set of predefined transaction codes.

By way of example, and not by limitation, the computer system 202 classifies each transaction of the set of transactions 214 into the at least one category of the set of categories. The computer system 202 classifies transaction A including the transaction code “FHA” into the loan category based on the application of the first ML model 206A of the set of ML models 206. The computer system 202 further classifies transaction B which includes the transaction code “DTCC” into the investment category. The computer system 202 further classifies transaction C including the transaction remarks “800 square feet real estate” into the real estate category. In an embodiment of the disclosure, the first ML model 206A performs text analysis of the transaction remarks of transaction C “800 square feet real estate” and then classifies transaction C into the real estate category. The computer system 202 further classifies transaction F including the payee data “User Y2” into the transfer category. The computer system 202 further classifies transaction G which includes the transaction remarks “gold purchase” into the jewelry category. In an embodiment of the disclosure, the first ML model 206A performs text analysis of the transaction remarks of transaction G “gold purchase” and then classifies transaction G into the jewelry category The computer system 202 further classifies transaction J which includes the payee data “User Y3” into the transfer category.

In an alternate embodiment of the disclosure, the computer system 202 classifies each transaction of the set of transactions into the at least one category of the set of categories based on the identification of the one or more recurring transactions. By way of example, and not by limitation, the computer system 202 classifies transaction D and transaction H into the loan category as each of the transaction A, transaction D, and transaction H are recurring transactions. Similarly, the computer system 202 classifies transaction E and transaction I into the investment category as each of transaction B, transaction E, and transaction I are recurring transactions. The classified set of transactions are shown in Table 3 below:

TABLE 3
Classified set of transactions associated with “User Y1”

| Transaction | Category |
|---|---|
| Transaction A, Transaction D and | Loan Category |
| Transaction H | |
| Transaction B, Transaction E and | Investments Category |
| Transaction I | |
| Transaction C | Real Estate Category |
| Transaction G | Jewelry Category |
| Transaction F and Transaction J | Transfer Category |

At 316, a second ML model application operation is performed. In the second ML model application operation, the computer system 202 applies the second ML model 206B of the set of ML models 206 to the classified set of transactions 214. The second ML model 206B is trained to determine the one or more financial holdings based on the classified set of transactions 214. In an embodiment of the disclosure, the second ML model 206B of the set of ML models 206 analyzes the patterns and relationships within the classified set of transactions 214 based on its training data and determines the one or more financial holdings. The one or more financial holdings represent an individual or entity's assets and liabilities. The assets include items of value such as cash, investments, property (real estate), jewelry, and the like. Liability refers to debts such as loans and mortgages. The one or more financial holdings provide insight into net worth, liquidity, and overall financial health. Details about the training of the second ML model 206B of the set of ML models 206 are provided, for example, in FIG. 5.

By way of example, and not by limitation, the computer system 202 applies the second ML model 206B of the set of ML model 206 to the classified set of transactions 214 that includes the classified transaction A, classified transaction D, and classified transaction H (classified into the loan category), the classified transaction B, classified transaction E, and classified transaction I (classified into the investment category), the classified transaction C (classified into the real estate category), the classified transaction F, and the classified transaction J (classified into the transfer category), and the classified transaction G (classified into the jewelry category). The second ML model 206B of the set of ML models 206 analyzes the patterns and relationships between the classified set of transactions 214 based on its training data and determines the one or more financial holdings.

At 318, a financial holdings determination operation is performed. In the financial holdings determination operation, the computer system 202 determines the one or more financial holdings associated with the specific user 216. In an embodiment of the disclosure, the computer system 202 determines the one or more financial holdings associated with the specific user 216 based on the application of the second ML model 206B to the classified set of transactions. In an embodiment of the disclosure, the one or more financial holdings include one or more immovable assets associated with the specific user 216, the one or more bank accounts associated with the specific user 216, the one or more investments associated with the specific user 216, the jewelry information associated with the specific user 216, and the one or more loans associated with the specific user 216. The one or more immovable assets refer to the real estate purchased or sold by the specific user 216. The one or more bank accounts associated with the specific user 216 refer to the one or more alternate bank accounts registered under the name of the specific user 216, one or more bank accounts registered under the name of the family members of the specific user 216, or one or more bank accounts registered under the name of the nominee of the specific user 216 at the specific bank. The one or more bank accounts associated with the specific user 216 further includes the one or more alternate bank accounts of the specific user 216 and one or more bank accounts of the family members of the family members of the specific user 216 registered at one or more banks other than the specific bank. The one or more investments refer to the one or more investment plans in which the specific user 216 has registered. The jewelry information indicates the jewelry purchased or sold by the specific user 216. The one or more loans refer to the one or more loan schemes under which the specific user 216 has registered.

By way of example, and not by limitation, the computer system 202 determines the one or more financial holdings associated with “User Y1” based on the application of the second ML model 206B to the classified set of transactions 214 that includes the classified transaction A, classified transaction D and classified transaction H (classified into the loan category), the classified transaction B, classified transaction E and classified transaction I (classified into the investment category), the classified transaction C (classified into the real estate category), the classified transaction F and classified transaction J (classified into the transfer category), and the classified transaction G (classified into the jewelry category).

The computer system 202 determines five financial holdings associated with “User Y1”. The computer system 202 determines that “User Y1” had borrowed a home loan based on the classified transaction A, classified transaction D, and classified transaction H (classified into the loan category). The computer system 202 further determines that “User Y1” had invested in a SIP investment plan based on the classified transaction B, classified transaction E, and classified transaction I (classified into the investment category). The computer system 202 further determines real estate associated with “User Y1” based on the classified transaction C (classified into the real estate category). The computer system 202 further determines two alternate bank accounts “User Y2” and “User Y3” associated with “User Y1”, who is the wife (nominee) and the brother, respectively, of “User Y1”. The computer system 202 further determines that “User Y1” had purchased jewelry based on transaction G (classified into the jewelry category).

At 320, a set of features determination operation is performed. In the set of features determination operation, the computer system 202 determines a set of features associated with the determined one or more financial holdings. In an embodiment of the disclosure, the set of features includes a first feature associated with the associated with price value of each financial holding of the one or more financial holdings, a second feature associated with a maturity amount of each financial holding of the one or more financial holdings, and a third feature associated with a payment schedule of each financial holding of the one or more financial holdings.

The price value of each financial holding of the one or more financial holdings refers to the price value of the corresponding financial holding at a current date (the date on which the computer system 202 determines the one or more financial holdings). For example, the price value of 800 square feet of real estate in Location A2 at the current date is $500000. The maturity amount of each financial holding of the one or more financial holding refers to the total value that the corresponding financial holding will yield at the end of its term or maturity period. The maturity period is the time until the corresponding financial holding reaches the point when the user can receive the investment back (in case of investment plans) or when the principal amount is due to be paid (in case of loans), along with any interest or returns. For example, the maturity amount of an investment plan X after 3 years from the current date is $12,500. The payment schedule of each financial holding of the one or more financial holdings refers to a structured plan that outlines the timings and amounts of payments due for the corresponding financial holding. For example, the payment schedule of a loan Y is $500 monthly.

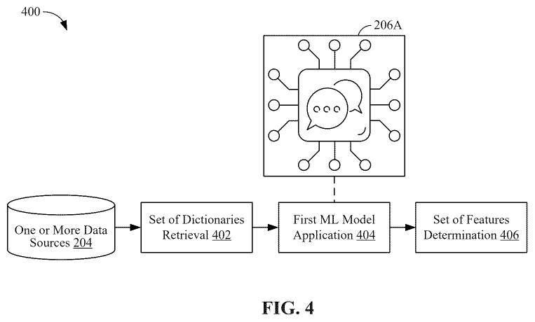

In an embodiment of the disclosure, the computer system 202 obtains a set of dictionaries from the one or more data sources 204. The computer system 202 further applies the first ML model 206A of the set of ML models 206 to the set of dictionaries. The computer system 202 further determines the set of features associated with the determined one or more financial holdings that are associated with the user based on the application of the first ML model 206A to the set of dictionaries. Details about the set of dictionaries retrieval and the set of features determination are further provided, for example, in FIG. 4.

By way of example, and not by limitation, the computer system 202 determines the set of features associated with the one or more financial holdings that are associated with “User Y1”. The computer system 202 determines that “User Y1” is associated with two bank accounts under the specific bank. One bank account number is “XXX2256” and is registered under the name of “User Y2”, who is the wife and the nominee of “User Y1”. The second bank account number is “YYY3244” and is registered under the name of “User Y3”, who is the brother of “User Y1”. The computer system 202 further determines that “User Y1” had borrowed an XYZ scheme-based home loan from the specific bank based on the amount of the interest payments ($500) from the bank account of “User Y1”. The computer system 202 determines that “User Y1” is yet to pay two installments of the XYZ scheme-based home loan based on the transaction data 212. The computer system 202 determines the payment schedule of the XYZ scheme-based home loan as $500 per month for two months. The computer system 202 further determines that “User Y1” had invested in ABC investment plan based on the amount of payments ($250). The computer system 202 further determines that the maturity amount of the ABC investment plan is $12500, and the maturity period of the ABC investment plan is 3 months from the current date. The computer system 202 further determines that “User Y1” purchased 800 square feet of real estate (for example real estate X) in Location A2 based on the transaction remarks. The computer system 202 further determines that 800 square feet of real-estate in Location A2 at the current date would cost $700000 (the price value feature) based on the set of dictionaries obtained from the one or more data sources 204. The computer system 202 further determines that “User Y1” purchased gold jewelry W worth $50000 on “1 Oct. 2020”. The computer system 202 further obtains a conversion factor for determining the price value of the purchased gold jewelry W at the current date. The computer system 202 further determines the price value of the purchased gold jewelry “W” as “$53000”.

At 322, a wealth portfolio catalog generation operation is performed. In the wealth portfolio catalog generation operation, the computer system 202 generates the wealth portfolio catalog associated with the specific user 216. In an embodiment of the disclosure, the computer system 202 generates the wealth portfolio associated with the specific user 216 based on the determination of the one or more financial holdings. In an embodiment of the disclosure, the computer system 202 generates the wealth portfolio catalog based on the determination of the set of features. The wealth portfolio catalog includes the one or more financial holdings associated with the specific user 216 and the set of features (the price values, the maturity amounts, and the payment schedules) associated with the determined one or more financial holdings. The wealth portfolio catalog is a structured collection of the one or more financial holdings that represent an individual or entity's financial holdings. The wealth portfolio catalog includes all assets, such as cash, investments, property (real estate), jewelry, and the like of the specific user 216. The wealth portfolio catalog also includes liabilities, like loans and debts.

By way of example, and not by limitation, the computer system 202 generates the wealth portfolio catalog associated with “User Y1” based on the determination of the one or more financial holdings associated with “User Y1” and the determination of the set of features. The wealth portfolio catalog associated with “User Y1” includes the one or more financial holdings associated with “User Y1” and the set of features. The wealth portfolio catalog can be represented in Table 4 given below:

TABLE 4
Wealth Portfolio Catalog associated with “User Y1”
Wealth Portfolio Catalog

| | | | Price Value | Maturity Amount | Payment |
|---|---|---|---|---|---|
| | | | (current date) | (Maturity Period) | Schedule |
| 1. | Bank | 1. XXX2256 - User Y2 | 1. User Y2 - | | |
| | Accounts | (Wife and Nominee) | $500000 | | |
| | | 2. YYY3244- User Y3 | 2. User Y3 - | | |
| | | (Brother) | $800000 | | |
| 2. | Immovable | Real Estate X | $700000 | | |
| | Assets | (800 square feet) | | | |
| 3. | Jewelry | Gold Jewelry W | $53000 | | |
| | | (worth $50000) | | | |
| 4. | Investment | ABC Investment Plan | | $12500 | |
| | | | | (3 months) | |
| 5. | Loan | XYZ scheme-based | | | $500 per month |
| | | Home Loan | | | (for next two |
| | | | | | months) |

At 324, the wealth portfolio output operation is performed. In the wealth portfolio output operation, the computer system 202 outputs the generated wealth portfolio catalog. In an embodiment of the disclosure, the computer system 202 outputs the generated wealth portfolio catalog based on the generation of the wealth portfolio catalog. In an embodiment of the disclosure, the computer system 202 renders the generated wealth portfolio catalog on the user device 208. In an embodiment of the disclosure, the computer system 202 performs the determination of the one or more financial holdings and the generation of the wealth portfolio catalog by analyzing only the transaction data 212 associated with the specific user 216. Therefore, the disclosed system eliminates dependency on various data sources (like servers of FDs, Mutual Funds, Stocks, and the like) for the calculation of the wealth catalog (as done in the traditional methods). Furthermore, the computer system 202 does not require real-time tracking of investments made by the specific user 216, which reduces the overall processing time of the computer system 202 for the determination of the one or more financial holdings. The real-time tracking of user investments is a time-consuming and tedious task that requires high-end computing resources. Moreover, the computer system 202 determines the one or more investments and the one or more loans (digital assets) as well as the one or more immovable assets and the jewelry information (non-digital assets). The computer system 202 further eliminates the need for high-end computing resources for the determination of the one or more financial holdings. The need for these high-end computational resources increases the overall cost of the determination of the one or more financial holdings. Hence, the computer system 202 reduces the overall cost of the process of determination of the one or more financial holdings.

At 326, a feedback reception operation is performed. In the feedback reception operation, the computer system 202 receives feedback from the specific user 216 or from the family member of the specific user 216. In an embodiment of the disclosure, the computer system 202 receives the feedback from the specific user 216 in response to the generated wealth portfolio catalog. In an embodiment of the disclosure, the computer system 202 receives feedback from the user device 208. The feedback is a message that the computer system 202 receives to determine whether the generated wealth portfolio catalog is correct or not. The computer system 202 receives positive feedback that indicates that the generated wealth portfolio catalog is correct. The computer system 202 receives negative feedback that indicates that the generated wealth portfolio catalog is incorrect. In an embodiment of the disclosure, the negative feedback further indicates at least one financial holding associated with the specific user 216 is not present in the generated wealth portfolio catalog. In an embodiment of the disclosure, the negative feedback includes a message that “Financial holding X is not present in the wealth portfolio catalog”.

At 328, the second ML model training operation is performed. In an embodiment of the disclosure, the computer system 202 trains the second ML model 206B based on the feedback. The computer system 202 adjusts the weights and the regularization parameters based on the negative feedback. The computer system 202 adjusts the weights and the regularization parameters of the neural network corresponding to the second ML model 206B of the set of ML models 206 for minimizing the value of error based on the negative feedback. Specifically, the computer system 202 provides the second ML model 206B with the message that includes the message that “Financial holding X is not present in the determined wealth portfolio catalog. The computer system 202 further adjusts the weights and regularization parameters. The computer system 202 adjusts the weights and the regularization parameters associated with the second ML model 206B of the set of ML models 206 using back-propagation technique. Details about the back-propagation technique are known in the art and have been omitted for the sake of brevity.

In an alternate embodiment of the disclosure, the computer system 202 further reinforces the weights and the regularization parameters of the neural network corresponding to the second ML model 206B of the set of ML models 206 based on the positive feedback. The computer system 202 performs the training based on the feedback to fine-tune the second ML model 206B of the set of ML models 206 and to ensure that the generated wealth portfolio catalog is correct. Details about the training of the second ML model 206B of the set of ML models 206 are further provided, for example, in FIG. 5.

At 330, it may be determined whether the received feedback is the positive feedback or not. In an embodiment of the disclosure, the computer system 202 receives the negative feedback. The control of operations proceeds to 316 based on the determination that the computer system 202 receives the negative feedback. The negative feedback indicates that the at least one financial holding associated with the specific user 216 is not present in the generated wealth portfolio catalog. The negative feedback further indicates that the generated wealth portfolio catalog is incorrect. In an embodiment of the disclosure, the computer system 202 further repeats the operations from 316 to 324 to re-generate the wealth portfolio catalog based on the determination that the computer system 202 receives the negative feedback. In an embodiment of the disclosure, the computer system 202 further ensures that the at least one financial holding is present in the re-generated wealth portfolio catalog. In an alternate embodiment of the disclosure, the computer system 202 receives the positive feedback. The control of operations ends at 332 based on the determination that the computer system 202 receives the positive feedback.

FIG. 4 is a diagram that illustrates exemplary operations for determination of a set of features for determination of unclaimed assets using machine learning (ML) models, in accordance with an embodiment of the disclosure. FIG. 4 is explained in conjunction with elements from FIG. 1, FIG. 2, and FIG. 3. The block diagram 400 further illustrates exemplary operations from 402 to 406, as described herein. With reference to FIG. 4, there is further shown the one or more data sources 204 and the first ML model 206A of the set of ML models 206. The exemplary operations illustrated in the block diagram 400 start at 402 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 300 can be divided into additional blocks, combined into fewer blocks, or eliminated, depending on the implementation.

At 402, a set of dictionaries retrieval operation is performed. In the set of dictionaries retrieval operation, the computer system 202 obtains the set of dictionaries associated with the determined one or more financial holdings from the one or more data sources 204. The set of dictionaries includes one or more loan schemes that were in trend on the date on which the user borrowed the loan from the specific bank or paid the first installment of the specific bank. In an embodiment of the disclosure, the computer system 202 utilizes the first ML model 206A of the set of ML models 206 that is trained on a vast amount of historical text data (that includes facts and figures about the historical loan schemes) to extract the set of dictionaries. By way of example, and not by limitation, the computer system 202 obtains the one or more loan schemes such as a PQR scheme-based home loan and the XYZ scheme-based home loan. The set of dictionaries further includes one or more investment plans that were in trend when the user made the first transaction associated with the investment plan. In an embodiment of the disclosure, the computer system 202 utilizes the first ML model 206A of the set of ML models 206 that is trained on a vast amount of historical text data (that includes facts and figures about the historical investment plans) to extract the set of dictionaries. By way of example, and not by limitation, the computer system 202 obtains the one or more investment plans from the one or more data sources 204 such as the ABC investment plan and an EFG investment plan.

The set of dictionaries further includes the current price values of the real estate at specific locations and historical price values of real estate at specific locations. In an embodiment of the disclosure, the computer system 202 utilizes the first ML model 206A of the set of ML models 206 that is trained on a vast amount of historical text data (that includes facts and figures about the historical price values of real estate) to extract the set of dictionaries. In an embodiment of the disclosure, the computer system 202 further obtains the current price values of the real estate from the one or more data sources 204. The set of dictionaries further includes the current price values of the jewelry such as gold, silver, platinum, or the like at specific locations and historical price values of the jewelry at the specific locations. The set of dictionaries further includes the one or more one-time investment policies such as XYZ life insurance policy and ABC insurance policy. In an embodiment of the disclosure, the computer system 202 utilizes the first ML model 206A of the set of ML models 206 that is trained on a vast amount of historical text data (that includes facts and figures about the historical price values of jewelry) to extract the set of dictionaries. In an embodiment of the disclosure, the computer system 202 further obtains the current price values of the jewelry from the one or more data sources 204

At 404, a first ML model application operation is performed. In the first ML model application operation, the computer system 202 applies the first ML model 206A to the set of dictionaries. In an embodiment of the disclosure, the computer system 202 applies the first ML model 206A to the set of dictionaries to determine the set of features associated with the determined one or more financial holdings. In an embodiment of the disclosure, the first ML model 206A of the set of ML models 206 analyzes the set of dictionaries. The first ML model 206A of the set of ML models 206 analyzes the one or more loan schemes. By way of example, and not by limitation, the first ML model 206A analyzes the PQR scheme-based home loan and the XYZ scheme-based home loan. The first ML model 206A further identifies that the installment amount of XYZ scheme-based home loan matches with the installment amounts that are paid by the bank account of “User Y1” ($500) based on the transaction data 212 and the analysis. The first ML model 206A further determines that a total amount of $1000 is still needed from the bank account “User Y1” based on the transaction data 212. The first ML model 206A further determines the payment schedule of the XYZ scheme-based home loan as $500 per month for two months as the feature for the XYZ scheme-based home loan for “User Y1”.

The first ML model 206A similarly analyzes the one or more investment schemes. By way of example, and not by limitation, the first ML model 206A analyzes the ABC investment plan and the EFG investment plan. The first ML model 206A further determines that the installment amounts of the ABC investment plan match the installment amounts that are paid by the bank account of “User Y1” ($250). The first ML model 206A further determines the maturity amount of $12500 that “User Y1” would get after the completion of the investment plan. The first ML model 206A further determines that the maturity period of the ABC investment is 3 months from the current date.

The first ML model 206A further analyzes the current price values of the real estate at specific locations and historical price values of real estate at specific locations. By way of example, and not by limitation, the first ML model 206A then calculates the price value of the real estate property purchased by “User Y1” based on the analysis. The first ML model 206A further analyzes the current price values of the jewelry at specific locations and historical price values of jewelry at specific locations. By way of example, and not by limitation, the first ML model 206A then calculates the price value of the jewelry purchased by “User Y1” based on the analysis.

At 406, a set of features determination operation is performed. In the set of features determination operation, the computer system 202 determines the set of features associated with the determined one or more financial holdings. In an embodiment of the disclosure, the computer system 202 determines the set of features based on the application of the first ML model 206A to the set of dictionaries. In an embodiment of the disclosure, the set of features includes a first feature associated with the price value of each financial holding of the one or more financial holdings, a second feature associated with the maturity amount of each financial holding of the one or more financial holdings, and a third feature associated with the payment schedule of each financial holding of the one or more financial holdings.

By way of example, and not by limitation, the computer system 202 determines the set of features associated with the one or more financial holdings that are associated with “User Y1”. The computer system 202 determines that “User Y1” is associated with two bank accounts under the specific bank. One bank account number is “XXX2256” and is registered under the name of “User Y2”, who is the wife and the nominee of “User Y1”. The second bank account number is “YYY3244” and is registered under the name of “User Y3”, who is the brother of “User Y1”. The computer system 202 further determines that “User Y1” had borrowed an XYZ scheme-based home loan from the specific bank based on the application of the first ML model 206A to the set of dictionaries. The computer system 202 determines that “User Y1” is yet to pay two installments of the XYZ scheme-based home loan based on the transaction data 212. The computer system 202 determines the payment schedule of the XYZ scheme-based home loan as $500 per month for two months.

The computer system 202 further determines that “User Y1” had invested in ABC investment plan based on the amount of payments ($250) based on the application of the first ML model 206A to the set of dictionaries. The computer system 202 further determines that the maturity amount of the ABC investment plan is $12500, and the maturity period of the ABC investment plan is 3 months from the current date based on the application of the first ML model 206A to the set of dictionaries. The computer system 202 further determines that “User Y1” purchased 800 square feet of real estate (for example real estate X) in Location A2 based on the transaction remarks. The computer system 202 further determines that 800 square feet of real-estate in Location A2 at the current date would cost $700000 (the price value feature) based on application of the first ML model 206A to the current price values of the real estate at specific locations and historical price values of real estate at specific locations. The computer system 202 further determines that “User Y1” purchased gold jewelry worth $50000 on “1 Oct. 2020”. The computer system 202 further determines the price value of the purchased gold jewelry as “$53000” based on the application of the first ML model 206A to the current price values of the jewelry at specific locations and historical price values of jewelry at specific locations.

FIG. 5 is a diagram that illustrates training of a machine learning (ML) model for determination of unclaimed assets, in accordance with an embodiment of the disclosure. FIG. 5 is explained in conjunction with FIG. 1, FIG. 2, FIG. 3, and FIG. 4. As shown, there is a training portion above line 500 and an implementation portion below line 500. In the training portion above line 500, the computer system 202 obtains historical transaction information from the one or more data sources 204. The historical transaction information is associated with a set of users. The historical transaction information includes a classified set of historical transactions for the training 502 of the second ML model 206B of the set of ML models 206.

At 504, a historical transaction information retrieval operation is performed. In the historical transaction information retrieval operation, the computer system 202 obtains the historical transaction information from the one or more data sources 204. In an embodiment of the disclosure, the computer system 202 obtains historical transaction information that includes the classified set of historical transactions associated with a set of users. In an embodiment of the disclosure, the specific user 216 is excluded from the set of users. Each historical transaction of the classified set of historical transactions is classified into the at least one category of the set of categories. In an embodiment of the disclosure, the historical transaction information that includes the classified set of historical transactions may be a critical asset for understanding the patterns and relationships between the classified set of historical transactions and one or more historical financial holdings associated with the set of users for training 502 of the second ML model 206B.

By way of example, and not by limitation, the historical transaction information includes 9 classified transactions (Transaction A, Transaction B, Transaction C, Transaction D, Transaction E, Transaction F, Transaction G, Transaction H, and Transaction I) associated with 6 users (user A, user B, user C, user D, user E and user F). Transaction A is associated with user A and is classified into the deposit category (fixed deposit of $1000000). Transaction B is associated with user B and is classified into the jewelry category (jewelry purchase of $100000). Transaction C is associated with user C and is classified into the real estate category (real estate worth $4000000). Transaction D and Transaction E are associated with user D and are classified into the loan category. Transaction F and Transaction G are associated with the user E and are classified into the investment category. Transaction I and Transaction J are associated with user F and are classified into the transfer category. The payee of transaction H and transaction I is user G (user G is registered as the brother of user F and the nominee of user F). The historical transaction data can be represented in Table 5 shown below:

TABLE 5
Historical Transaction Data

| | | |
|---|---|---|
| Transaction A | User A | Deposit category |
| Transaction B | User B | Jewelry category |
| Transaction C | User C | Real Estate category |
| Transaction D, Transaction E | User D | Loan category |
| Transaction F, Transaction G | User E | Investment category |
| Transaction H, Transaction I | User F | Transfer category |

At 506, a historical financial holdings retrieval operation is performed. In the historical financial holdings retrieval operation, the computer system 202 obtains the one or more historical financial holdings from the one or more data sources 204. In an embodiment of the disclosure, the computer system 202 obtains the one or more historical financial holdings associated with the set of users. The one or more historical financial holdings represent the one or more assets, and the one or more liabilities associated with the set of users historically. In an embodiment of disclosure, the one or more historical financial holdings may be a critical asset for understanding the patterns and relationships between the classified set of historical transactions and the one or more historical financial holdings associated with the set of users for training 502 of the second ML model 206B.

By way of example, and not by limitation, the computer system 202 obtains the one or more financial holdings associated with the set of users (user A, user B, user C, user D, user E, and user F). The computer system 202 obtains a one-time investment life insurance scheme PQR associated with user A. The computer system 202 further obtains jewelry W purchased by user B. The computer system 202 further obtains real estate X owned by user C. The computer system 202 further obtains XYZ scheme-based home loan borrowed by user D. The computer system 202 further obtains the ABC investment plan in which user E has invested. The computer system 202 further obtains the bank account of user G who is registered as the brother and the nominee of user F. The one or more historical financial holdings can be represented in Table 6 as shown below:

TABLE 6
One or More Historical Financial Holdings

| | |
|---|---|
| User A | Life Insurance Scheme PQR |
| User B | Jewelry W |
| User C | Real Estate X |
| User D | XYZ scheme-based home loan |
| User E | ABC Investment Plan |
| User F | ZZZ245 - User G (Brother and Nominee) |

At 508, a training dataset determination operation is performed. In the training dataset determination operation, the computer system 202 determines a training dataset for training 502 of the second ML model 206B. In an embodiment of the disclosure, the computer system 202 determines the training dataset based on the historical transaction information and the one or more historical financial holdings associated with the set of users. The training dataset includes the classified set of historical transactions associated with the set of users as a set of input data and the one or more historical financial holdings associated with the set of users as a set of corresponding output data.

By way of example, and not by limitation, the computer system 202 determines the training dataset based on the classified set of transactions (Transaction A, Transaction B, Transaction C, Transaction D, Transaction E, Transaction F, Transaction G, Transaction H, and Transaction I) as the set of input data and the one or more historical financial holdings (Life Insurance Scheme PQR, Jewelry W, Real Estate X, XYZ scheme-based home loan, ABC Investment Plan, ZZZ245—User G (Brother and Nominee) as the set of corresponding output data. The training dataset can be represented in the Table 7 as shown below:

TABLE 7
Training Dataset

| Input Data | Output Data |
|---|---|
| Transaction A | Life Insurance Scheme PQR |
| Transaction B | Jewelry W |
| Transaction C | Real Estate X |
| Transaction D, Transaction E | XYZ scheme-based home loan |
| Transaction F, Transaction G | ABC Investment Plan |
| Transaction H, Transaction I | ZZZ245 - User G (Brother and Nominee) |

At 510, a second ML model training operation is performed. In the second ML model training operation, the computer system 202 trains the second ML model 206B of the set of ML model 206. In an embodiment of the disclosure, the computer system 202 trains the second ML model 206B of the set of ML models 206 based on the training dataset. In an embodiment of the disclosure, the computer system 202 provides the second ML model 206B with the training dataset. The second ML model 206B of the set of ML models 206 then analyzes the set of input data and the set of corresponding data in the training dataset to identify patterns and relationships between the set of input data and the set of corresponding output data. Specifically, the second ML model 206B of the set of ML model 206 determines a machine learning algorithm for determining the one or more financial holdings based on the identified patterns and relationships between the set of input data and the set of corresponding output data. The second ML model 206B of the set of ML models 206 further utilizes the machine learning algorithm for determining the one or more financial holdings based on the classified set of transactions.

In an embodiment of the disclosure, the training 502 of the second ML model corresponds to the tuning of one or more hyper-parameters associated with the second ML model 206B of the set of ML models 206 based on the training dataset. In an embodiment of the disclosure, the computer system 202 adjusts the one or more hyperparameters (the weights and the regularization parameters) of the neural network corresponding to the second ML model 206B based on the identified patterns and the identified relationships between the set of input data and the set of corresponding output data in the training dataset for determining the one or more financial holdings.

In an embodiment of the disclosure, the computer system 202 adjusts the one or more hyper-parameters of each node of the neural network corresponding to the second ML model 206B based on whether the predicted output of the final layer for each input data of the set of input data (from the training dataset) matches the actual output in the corresponding output data of the set of corresponding output data. The computer system 202 further calculates a loss function or a training error associated with the second ML model 206B based on a determination of whether the predicted output matches the actual output in the validation dataset or not. The computer system 202 further repeats the adjustment of one or more hyper-parameters until a minima of the loss function is achieved, or until the training error is minimized.

In the implementation portion below line 500, at 512 a classified set of transactions determination operation is performed. In the classified set of transactions determination operation, the computer system 202 determines the classified set of transactions based on the received transaction data 212. In an embodiment of the disclosure, the computer system 202 receives the transaction data 212 which includes the set of transactions associated with the first bank account of the user. The computer system 202 further applies the first ML model 206A of the set of ML models 206 to the transaction data 212 and classifies each transaction of the set of transactions into the at least one category of the set of categories. Then, the computer system 202 determines the classified set of transactions based on the application of the first ML model 206A to the transaction data 212. Details about the transaction data reception, the first ML model application, and the set of transaction classifications are provided, for example, in FIG. 1 and FIG. 3.

At 514, a second ML model application operation is performed. In the second ML model application operation, the computer system 202 applies the second ML model 206B of the set of ML models to the classified set of transactions. The second ML model 206B of the set of ML models 206 is trained to determine the one or more financial holdings associated with the user based on the classified set of transactions. In an embodiment of the disclosure, the second ML model 206B of the set of ML models 206 analyzes the classified set of transactions and the transaction data 212 and identifies the patterns and relationships based on the training dataset to determine the one or more financial holdings associated with the user. Details about the second ML model application are provided, for example, in FIG. 1 and FIG. 3.

At 516, a financial holdings determination operation is performed. In the financial holdings determination operation, the computer system 202 determines the one or more financial holdings associated with the specific user 216. In an embodiment of the disclosure, the computer system 202 determines the one or more financial holdings associated with the user based on the application of the second ML model 206B of the set of ML models 206 to the classified set of transactions. Details about the financial holding determination are provided, for example, in FIG. 1 and FIG. 3.

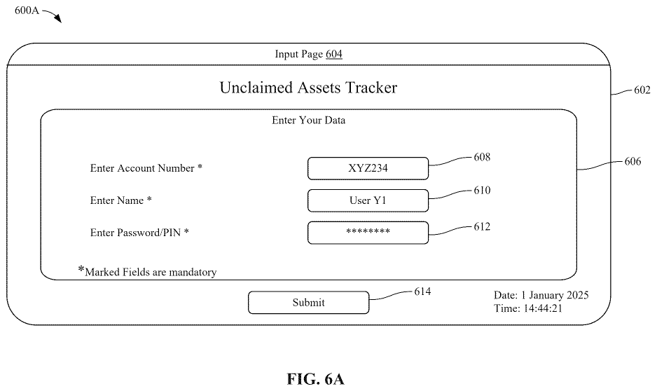

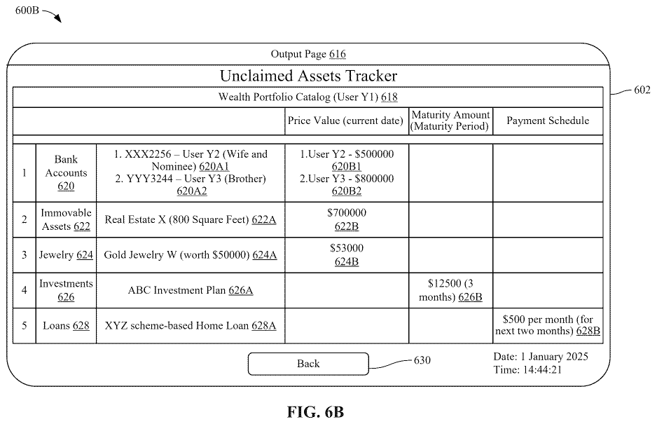

FIG. 6A is a diagram that illustrates an exemplary first user interface for determination of unclaimed assets using machine learning (ML) models, in accordance with an embodiment of the disclosure. FIG. 6A is explained in conjunction with elements from FIG. 1, FIG. 2, FIG. 3, FIG. 4, and FIG. 5. With reference to FIG. 6A, there is shown an exemplary diagram 600A that includes a user device 602 and an exemplary input page 604. The exemplary input page 604 includes a first user interface (UI) element 606, a second UI element 608, and a third UI element 610. The exemplary input page 604 further includes a fourth UI element 612 and a fifth UI element 614. The user device 602 is an exemplary embodiment of the user device 208 of FIG. 2.

With reference to FIG. 6A, the computer system 202 renders the input page 604 on the user interface (UI) of the user device 602. The input page 604 corresponds to a web page or online form that is designed to collect information from an entity or a user who wishes to determine the one or more financial holdings associated with the user (the specific user 216) or the one or more financial holdings associated with the family member of the user (the specific user 216). In an embodiment of the disclosure, the input page 604 is used to gather relevant details from the user to determine the one or more financial holdings.

The first UI element 606 corresponds to a textbox that includes a message for the specific user 216 (or the nominee of the specific user 216), for example, “Enter Your Data”. The first UI element 606 further includes the second UI element 608, the third UI element 610, and the fourth UI element 612. The second UI element 608 corresponds to a textbox labeled “Enter Account Number”. The second UI element 608 is used to obtain the account number of the bank account of the user (the specific user 216) or the account number of the bank account of the family member of the user (the specific user 216). For example, the computer system 202 obtains the account number as “XYZ234”. In an embodiment of the disclosure, the second UI element 608 is a mandatory input parameter that needs to be provided for the determination of the one or more financial holdings.

The third UI element 610 corresponds to a textbox and is labeled as “Enter Name”. The third UI element 610 is used to obtain the name of the user (the specific user 216) or the family member of the user (the specific user 216). For example, the computer system 202 obtains the name “User Y1”. The fourth UI element 612 corresponds to a textbox and is labeled as “Password”. The fourth UI element 612 may be used to obtain a security check parameter from the specific user 216 or the family member of the specific user 216. The security check parameter can be used as a parameter for accessing the wealth portfolio catalog of the specific user 216 and may be an identifier associated with the specific user 216. By way of example, and not by limitation, the security check parameter corresponds to one of a date of birth of the specific user 216, a mobile number of the specific user 216, a social security number (SSN) of the specific user 216, or the like. In an embodiment of the disclosure, the third UI element 610 and the fourth UI element 612 are mandatory input parameters that need to be provided for the determination of the one or more financial holdings.

The fifth UI element 614 corresponds to a button and is labeled as “Submit”. Upon selecting the fifth UI element 614, the computer system 202 receives the input information and further initiates the determination of the one or more financial holdings. In an embodiment of the disclosure, the computer system 202 receives the transaction data 212 that includes the set of transactions 214 associated with the user from the one or more data sources 204. The computer system 202 further applies the first ML model 206A of the set of ML models 206 to the transaction data 212 and classifies each transaction of the set of transactions into the at least one category of the set of categories based on the application of the first ML model 206A to the transaction data 212. The computer system 202 further applies the second ML model 206B of the set of ML models 206 to the classified set of transactions and determines the one or more financial holdings associated with the user based on the application of the second ML model 206B to the classified set of transactions. The computer system 202 further generates the wealth portfolio catalog based on the determined one or more financial holdings. Details about the one or more financial holdings determination operation are provided, for example, in FIG. 3.

FIG. 6B is a diagram that illustrates an exemplary second user interface for determination of unclaimed assets using machine learning (ML) models, in accordance with an embodiment of the disclosure. FIG. 6B is explained in conjunction with elements from FIG. 1, FIG. 2, FIG. 3, FIG. 4, FIG. 5, and FIG. 6A. With reference to FIG. 6B, there is shown an exemplary diagram 600B that includes the user device 602 and an exemplary output page 616. The exemplary output page 616 includes a sixth UI element 618 and a seventh UI element 630. The user device 602 is an exemplary embodiment of the user device 208 of FIG. 2.

With reference to FIG. 6B, the computer system 202 renders the output page 616 on the display unit (or the user interface) of the user device 602. The computer system 202 renders the generated wealth portfolio catalog on the output page 616 based on the determination of the one or more financial holdings. The output page 616 provides the information associated with the determined one or more financial holdings.

The sixth UI element 618 corresponds to a table and is labeled as “Wealth Portfolio Catalog (“User Y1”)”. The sixth UI element 618 represents the wealth portfolio catalog of “User Y1”. The sixth UI element 618 further includes a first table row 620, a second table row 622, a third table row 624, a fourth table row 626, and a fifth table row 628. The first table row 620 is labelled as “Bank Accounts”. The first table row 620 indicates the bank accounts associated with the specific user 216 (for example “User Y1”). The first table row 620 further includes a first bank account 620A1 which is labeled as “XXX2256-User Y2 (Wife and Nominee)”. The first bank account 620A1 indicates the account number and the name of the first bank account associated with the user (“User Y1”).

The first table row 620 further includes a second bank account 620A2 which is labeled as “YYY3244—User Y3 (Brother)”. The second bank account 620A2 indicates the account number and the name of the second bank account associated with the user (“User Y1”). The first table row 620 further includes a first current balance amount 620B1 of the first bank account 620A1 which is labeled as “User Y2-$500000”. The first current balance amount 620B1 indicates the current balance in the first bank account 620A1. The first table row 620 further includes a second current balance amount 620B2 of the second bank account 620A2 which is labeled as “User Y3—$800000”. The second current balance amount 620B2 indicates the current balance in the second bank account 620A2.

The second table row 622 is labelled as “Immovable Assets”. The second table row 622 indicates the one or more immovable assets associated with the specific user 216 (for example “User Y1”) and the set of features associated with the one or more immovable assets. The second table row 622 includes a first data cell 622A labeled as “Real Estate X (800 Square Feet)”. The first data cell 622A indicates the one or more immovable assets owned or rented by the specific user 216 (for example “User Y1”). The second table row 622 further includes a second data cell 622B labelled as “$700000”. The second data cell 622B indicates the current price value of the one or more immovable assets associated with the specific user 216.

The third table row 624 is labelled as “Jewelry”. The third table row 624 indicates the jewelry information associated with the specific user 216 and the set of features associated with the jewelry information. The third table row 624 includes a third data cell 624A labelled as “Gold Jewelry W (worth $50000)”. The third data cell 624A indicates the jewelry associated with the specific user 216. The third table row 624 further includes a fourth data cell 624B labelled as “$53000”. The fourth data cell indicates the current price value of the jewelry associated with the user.

The fourth table row 626 is labelled as “Investments”. The fourth table row 626 indicates the one or more investment plans associated with the specific user 216 and the set of features associated with the one or more investment plans. The fourth table row 626 includes a fifth data cell 626A labeled as “ABC Investment Plan”. The fifth data cell 626A indicates the one or more investment plans under which the specific user 216 had invested. The fourth table row 626 further includes a sixth data cell 626B labelled as “$12500 (3 months)”. The sixth data cell 626B indicates the maturity amount and the maturity period of the one or more investment plans under which the specific user 216 had invested.

The fifth table row 628 is labelled as “Loans”. The fifth table row 628 indicates the one or more loans associated with the specific user 216 and the set of features associated with the one or more loans. The fifth table row 628 includes a seventh data cell 628A labeled as “XYZ scheme-based Home Loan”. The seventh data cell 628A indicates the one or more loans that the specific user 216 had borrowed. The fifth table row 628 further includes an eighth data cell 628B labelled as “$500 per month (for the next two months)”. The eighth data cell 628B indicates the payment schedule of the one or more loans associated with the user. The seventh UI element 630 corresponds to a button and is labeled as “Back”. Upon selecting the seventh UI element 630, the computer system 202 renders the input page 604 on the user interface of the user device 602.

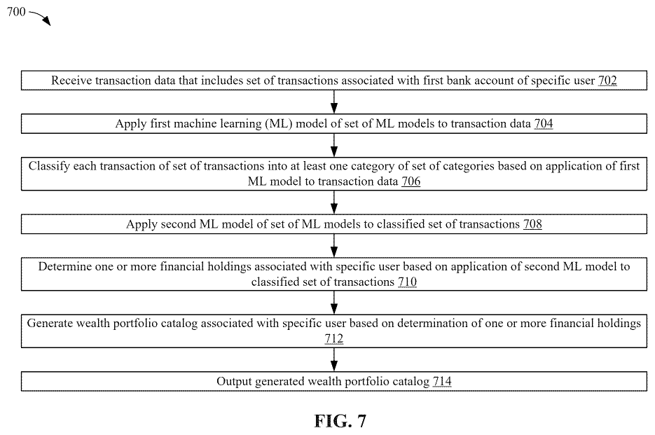

FIG. 7 is a diagram that illustrates a flowchart of an exemplary method for determination of unclaimed assets using machine learning (ML) models, in accordance with an embodiment of the disclosure. FIG. 7 is explained in conjunction with elements from FIG. 1, FIG. 2, FIG. 3, FIG. 4, FIG. 5, FIG. 6A and FIG. 6B. With reference to FIG. 7, there is shown a flowchart 700. The operations of the exemplary method may be executed by any computing system, for example, by the computer 102 of FIG. 1 or the computer system 202 of FIG. 2. The operations of the flowchart 700 may start at 702.

At 702, the transaction data 212 which includes the set of transactions 214 associated with the first bank account of the specific user 216 is received. In an embodiment of the disclosure, the computer system 202 receives the transaction data 212 which includes the set of transactions 214 associated with the first bank account of the specific user 216. Details about the transaction data reception operation are provided, for example, in FIG. 3.

At 704, the first ML model 206A of the set of ML models 206 is applied to the transaction data 212. In an embodiment of the disclosure, the computer system 202 applies the first ML model 206A of the set of ML models 206 to the transaction data 212. Details about the first ML model application operation are provided, for example, in FIG. 3.

At 706, each transaction of the set of transactions 214 is classified into the at least one category of the set of categories based on the application of the first ML model 206A to the transaction data 212. In an embodiment of the disclosure, the computer system 202 each transaction of the set of transactions 214 into the at least one category of the set of categories based on the application of the first ML model 206A to the transaction data 212. Details about the set of transaction classifications are provided, for example, in FIG. 3.

At 708, the second ML model 206B of the set of ML models 206 is applied to the classified set of transactions. In an embodiment of the disclosure, the computer system 202 applies the second ML model 206B of the set of ML models 206 to the classified set of transactions. Details about the second ML model application operation are provided, for example, in FIG. 3.

At 710, the one or more financial holdings associated with the specific user 216 are determined based on the application of the second ML model 206B to the classified set of transactions. In an embodiment of the disclosure, the computer system 202 determines the one or more financial holdings associated with the specific user 216 based on the application of the second ML model 206B to the classified set of transactions. Details about the one or more financial holdings determination are provided, for example, in FIG. 3.

At 712, the wealth portfolio catalog associated with the specific user 216 is generated based on the determination of the one or more financial holdings. In an embodiment of the disclosure, the computer system 202 generates the wealth portfolio catalog associated with the specific user 216 based on the determination of the one or more financial holdings. Details about the wealth portfolio catalog generation operation are provided, for example, in FIG. 3.

At 714, the wealth portfolio catalog is outputted. In an embodiment of the disclosure, the computer system 202 outputs the wealth portfolio catalog. Details about the wealth portfolio catalog output operation are provided, for example, in FIG. 3, FIG. 6A and FIG. 6B.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
receiving, by a computer, transaction data comprising a plurality of transactions associated with a first bank account of a specific user;
processing, by the computer, the transaction data using one or more natural language processing (NLP) techniques to extract one or more key identifiers from textual information associated with each transaction of the plurality of transactions, wherein the textual information includes transaction remarks and a transaction code;
applying, by the computer, a first machine learning (ML) model of a set of ML models to the transaction data including the extracted one or more key identifiers, wherein
the applying of the first ML model comprises analyzing the transaction code, associated with a transaction, which indicates that the transaction is associated with an investment category of a plurality of categories, and
the plurality of transactions includes the transaction;
identifying, by the computer, one or more recurring transactions from the plurality of transactions based on the transaction data, wherein each recurring transaction of the one or more recurring transactions comprises a same transaction amount that is transferred from the first bank account to a second bank account in fixed intervals of time;
classifying, by the computer, each transaction of the plurality of transactions into at least one category of the plurality of categories based on the identifying of the one or more recurring transactions and the applying of the first ML model to the transaction data;
applying, by the computer, a second ML model of the set of ML models to the classified plurality of transactions;
determining, by the computer, one or more financial holdings associated with the specific user based on the application of the second ML model to the classified plurality of transactions;
generating, by the computer, a wealth portfolio catalog associated with the specific user based on the determination of the one or more financial holdings; and
outputting, by the computer, the wealth portfolio catalog.

2. The computer-implemented method of claim 1, wherein the plurality of categories is selected from the group consisting of a deposit category, a loan category, a real estate category, a jewelry category, and a transfer category, wherein the transfer category is associated with a transfer of funds from the first bank account of the specific user to the second bank account of the specific user.

3. The computer-implemented method of claim 1, further comprising:
obtaining, by the computer, a set of dictionaries associated with the one or more financial holdings;
applying, by the computer, the first ML model of the set of ML models to the set of dictionaries;
determining, by the computer, a set of features associated with each financial holding of the one or more financial holdings based on the applying of the first ML model to the set of dictionaries; and
generating, by the computer, the wealth portfolio catalog associated with the specific user based on the determining of the set of features.

4. The computer-implemented method of claim 3, wherein the set of features is selected from the group consisting of a first feature associated with a price value of each financial holding of the one or more financial holdings, a second feature associated with a maturity amount of each financial holding of the one or more financial holdings, and a third feature associated with a payment schedule of each financial holding of the one or more financial holdings.

5. (canceled)

6. The computer-implemented method of claim 1, wherein the one or more key identifiers are selected from the group consisting of a monetary value associated with each transaction of the plurality of transactions, a transaction date associated with each transaction of the plurality of transactions, timestamp data associated with each transaction of the plurality of transactions, payee data associated with each transaction of the plurality of transactions, and payer data associated with each transaction of the plurality of transactions.

7. The computer-implemented method of claim 1, further comprising:
applying, by the computer, one or more data processing techniques to the transaction data;
generating, by the computer, one or more tokens associated with the plurality of transactions based on the applying of the one or more data processing techniques, wherein each token of the one or more tokens is associated with a corresponding transaction of the plurality of transactions; and
extracting, by the computer, the one or more key identifiers based on the generation of the one or more tokens.

8. (canceled)

9. The computer-implemented method of claim 1, further comprising:
receiving, by the computer, feedback from the specific user; and
training, by the computer, the second ML model of the set of ML models based on the feedback.

10. The computer-implemented method of claim 1, further comprising:
obtaining, by the computer, historical transaction data comprising a classified set of historical transactions associated with a set of users, wherein each historical transaction of the classified set of historical transactions is classified into the at least one category of the plurality of categories, and wherein the specific user is excluded from the set of users;
obtaining, by the computer, one or more historical financial holdings associated with the set of users;
determining, by the computer, a training dataset based on the historical transaction data and the one or more historical financial holdings; and
training, by the computer, the second ML model of the set of ML models based on the training dataset.

11. The computer-implemented method of claim 1, wherein the one or more financial holdings are selected from the group consisting of one or more immovable assets associated with the specific user, one or more bank accounts associated with the specific user, one or more investments associated with the specific user, jewelry information associated with the specific user, and one or more loans associated with the specific user.

12. A computer system, comprising:
a processor set;
one or more computer-readable storage media; and
program instructions stored on the one or more computer-readable storage media, the program instructions executable by the processor set to cause the processor set to:
receive transaction data that comprises a plurality of transactions associated with a first bank account of a specific user;
process the transaction data using one or more natural language processing (NLP) techniques to extract one or more key identifiers from textual information associated with each transaction of the plurality of transactions, wherein the textual information includes transaction remarks and a transaction code;
apply a first machine learning (ML) model of a set of ML models to the transaction data and the extracted one or more key identifiers, wherein
the application of the first ML model comprises analysis of the transaction code associated with the transaction, which indicates that the transaction is associated with an investment category of the plurality of categories, and
the plurality of transactions includes the transaction;
identify one or more recurring transactions from the plurality of transactions based on the transaction data, wherein each recurring transaction of the one or more recurring transactions comprises a same transaction amount that is transferred from the first bank account to a second bank account in fixed intervals of time;
classify each transaction of the plurality of transactions into at least one category of the plurality of categories based on the identification of the one or more recurring transactions and the application of the first ML model to the transaction data;
apply a second ML model of the set of ML models to the classified plurality of transactions;
determine one or more financial holdings associated with the specific user based on the application of the second ML model to the classified plurality of transactions;
generate a wealth portfolio catalog associated with the specific user based on the determination of the one or more financial holdings; and
output the generated wealth portfolio catalog.

13. The computer system of claim 12, wherein the plurality of categories is selected from the group consisting of a deposit category, a loan category, a real estate category, a jewelry category, and a transfer category, wherein the transfer category is associated with a transfer of funds from the first bank account of the specific user to the second bank account of the specific user.

14. The computer system of claim 12, wherein the program instructions further cause the processor set to:
obtain a set of dictionaries associated with the determined one or more financial holdings;
apply the first ML model of the set of ML models to the set of dictionaries;
determine a set of features associated with each financial holding of the one or more financial holdings based on the application of the first ML model to the set of dictionaries; and
generate the wealth portfolio catalog associated with the specific user based on the determination of the set of features.

15. The computer system of claim 14, wherein the set of features is selected from the group consisting of a first feature associated with a price value of each financial holding of the one or more financial holdings, a second feature associated with a maturity amount of each financial holding of the one or more financial holdings, and a third feature associated with a payment schedule of each financial holding of the one or more financial holdings.

16. (canceled)

17. The computer system of claim 12, wherein the one or more key identifiers are selected from the group consisting of a monetary value associated with each transaction of the plurality of transactions, a transaction date associated with each transaction of the plurality of transactions, timestamp data associated with each transaction of the plurality of transactions, payee data associated with each transaction of the plurality of transactions, and payer data associated with each transaction of the plurality of transactions.

18. (canceled)

19. The computer system of claim 12, wherein the one or more financial holdings are selected from the group consisting of one or more immovable assets associated with the specific user, one or more bank accounts associated with the specific user, one or more investments associated with the specific user, jewelry information associated with the specific user, and one or more loans associated with the specific user.

20. A computer-program product for determination of one or more financial holdings associated with a specific user, the computer-program product comprising:
one or more computer-readable storage media; and
program instructions stored on the one or more computer-readable storage media to perform operations comprising:
receiving transaction data that comprises a plurality of transactions associated with a first bank account of the specific user;
processing the transaction data using one or more natural language processing (NLP) techniques to extract one or more key identifiers from textual information associated with each transaction of the plurality of transactions, wherein the textual information includes transaction remarks and a transaction code;
applying a first machine learning (ML) model of a set of ML models to the transaction data including the extracted one or more key identifiers, wherein
the applying of the first ML model comprises analyzing the transaction code, associated with a transaction, which indicates that the transaction is associated with an investment category of a plurality of categories, and
the plurality of transactions includes the transaction;
identifying one or more recurring transactions from the plurality of transactions based on the transaction data, wherein each recurring transaction of the one or more recurring transactions comprises a same transaction amount that is transferred from the first bank account to a second bank account in fixed intervals of time;
classifying each transaction of the plurality of transactions into at least one category of the plurality of categories based on the identifying of the one or more recurring transactions and the applying of the first ML model to the transaction data;
applying a second ML model of the set of ML models to the classified plurality of transactions;
determining the one or more financial holdings associated with the specific user based on the application of the second ML model to the classified plurality of transactions;
generating a wealth portfolio catalog associated with the specific user based on the determination of the one or more financial holdings; and
outputting the generated wealth portfolio catalog.
